(19) United States
(12) Patent Application Publication
(10) Pub. No.: US 2013/0159445 A1
(43) Pub. Date: Jun. 20, 2013

(54) MULTI-MEDIA ELECTRONIC GREETING CARD WITH SOCIAL MEDIA COMPONENT

(71) Applicants: Lark Zonka, Madison, WI (US); Kevin P. Rizzuto, Milwaukee, WI (US)

(72) Inventors: Lark Zonka, Madison, WI (US); Kevin P. Rizzuto, Milwaukee, WI (US)

(73) Assignee: ZONKA AND ASSOCIATES, Madison, WI (US)

(21) Appl. No.: 13/814,990

(22) PCT Filed: Aug. 10, 2011
(86) PCT No.: PCT/US11/47208

§ 371 Date: Mar. 5, 2013

Related U.S. Application Data
(60) Provisional application No. 61/372,363, filed on Aug. 10, 2010.
(60) Provisional application No. 61/490,766, filed on May 27, 2011.

(51) Int. Cl. H04L 12/58

(52) U.S. Cl. CPC H04L 51/10
USPC 709/206

(57) ABSTRACT

A system and method of generating and sending an electronic greeting card. Webpage data is generated for display to a user. User browsing and selection input is received and webpage data is updated for display back to the user. Licensed media for attachment to the electronic greeting card is also displayed. An indication of particular licensed media that, if purchased, results in charitable donations is also displayed. The electronic greeting card is generated based on the remote user input received. Generated electronic greeting cards may include attached licensed music or links thereto that can be downloaded and stored locally or remotely for a recipient's later playback. The system and method may also include a social networking component whereby user pages are linked together for sharing and viewing of media and e-cards. The system and method may also include location-based features that use global positioning satellite (GPS) information.

### BACKGROUND

This invention relates to the generation and distribution of electronic greeting cards.

### SUMMARY

In one embodiment, the invention provides a system for generating an electronic greeting card including a server operable to receive input from a remote user device. The server includes a website module for generating webpage data and receiving user input, a calendar generating module for generating a calendar with event data, a card generating module for generating an electronic greeting card, a user information module for maintaining user information, and a payment module for effecting the purchase of the electronic greeting card. The server stores data to and loads data from databases including a user information database, an e-card database, a text database, a media database, an events database, and a mailing list database. The databases also include a relationship map that defines relationships among content stored in the databases. The card generating module is operable to generate a card based on user input. The card is sent by email, for example, and includes attached licensed media. The attached licensed media is operable to be stored locally on the remote user device and to be played by the remote user device without an Internet connection.

In another embodiment, the invention provides a method for generating an electronic greeting card. The method includes iteratively generating webpage data and receiving user input related to electronic greeting cards until the electronic greeting card selection is complete. The method also includes generating an electronic greeting card based on the user input, sending the card by email, and attaching licensed media to the email. The method also includes completing a purchase transaction for the electronic greeting card and attached licensed media, and sending the electronic greeting card via email. The attached licensed media is operable to be stored locally on the remote user device and to be played by the remote user device without an Internet connection.

In another embodiment, the invention provides a system for generating an electronic greeting card, the system including a server operable to receive selection data from a remote user device. The server includes a website module for generating webpage data including one of a calendar with customized event data, suggested e-card templates, suggested media, and suggested events. At least one of the suggested e-card templates and suggested media also includes an indication of whether purchase thereof will result in a charitable donation. The charitable donation is made by one of an operator of the website or a license holder that licenses the suggested media, media associated with the e-card template, and the e-card template. A calendar generating module generates customized event data based on stored user data in a database. The stored user data includes at least one of particular events stored by the user and user preferences. The user preferences are stored by one of the user and a user information module that analyzes earlier user browsing actions and/or purchases.

In another embodiment, the invention provides a method for generating an electronic greeting card. The method includes iteratively generating webpage data and receiving user input related to electronic greeting cards until the electronic greeting card selection is complete. The webpage data includes at least one of a calendar with customized event data, suggested e-card templates, suggested media, and suggested events. At least one of the suggested e-card templates and suggested media also includes an indication of whether purchase thereof will result in a charitable donation. The charitable donation is made by one of an operator of the website or a license holder that licenses the suggested media, media associated with the e-card template, and the e-card template. The calendar is generated based on stored user data in a database. The stored user data includes at least one of particular events stored by the user and user preferences. The user preferences are stored by one of the user and a user information module that analyzes earlier user browsing actions and/or purchases. The method also includes generating an electronic greeting card for sending by email based on the user input and attaching licensed media. The method also includes completing a purchase transaction for the electronic greeting card and sending the electronic greeting card via email.

In some embodiments, in place of or in addition to sending licensed media to an intended recipient as an attachment to the electronic greeting card, the media is provided to a remote data storage location accessible by the recipient. In other embodiments, in place of or in addition to sending licensed media to the recipient as an attachment to the electronic greeting card, a license is granted to the recipient that allows access to remotely stored music.

In some embodiments, the invention provides a method for generating an electronic greeting card. The method includes receiving, by a server, user information indicating preferences of a user and generating, by the server, a web page with an event calendar. The method further includes associating a holiday with the user based on the user information, populating the event calendar with user-specific events, including the holiday, and sending the web page to a remote user device. The server then receives an event selection from the user. The event selection includes the user selecting an event of the user-specific events of the event calendar. The server the sends an electronic greeting card template based on the event selection, and receives recipient information identifying a recipient for the electronic greeting card template. The server then generates an electronic greeting card based on the electronic greeting card template and with at least one of a media file and a link to the media file. The method further includes sending the electronic greeting card to the recipient.

In some embodiments, the invention provides an electronic greeting card server. The server includes a website module, a user information module, a calendar generating module, and an e-card generating module. The website module generates a web page for a user, wherein the web page includes an event calendar. The user information module receives user information indicating preferences of a user. The calendar generating module associates a holiday with the user based on the user information and populates the event calendar with user-specific events, including the holiday. The e-card generating module receives an event selection from the user, wherein the event selection includes the user selecting an event of the user-specific events of the event calendar. The e-card generating module sends, to the user, an electronic greeting card template based on the event selection and receives recipient information identifying a recipient for the electronic greeting card template. The e-card generating module further generates an electronic greeting card based on the electronic greeting card template and with at least one of a media file and a link to the media file and sends the electronic greeting card to the recipient.

In some embodiments, the invention provides a method of sending a location-based invitation. In the method, a server receives a member check-in indicating a geographic location of a remote computing device. The server also receives a request from a privileged member to send a location-based invitation, wherein the location-based invitation specifies a geographic area. The method further includes determining whether the geographic location is within the geographic area. When the geographic location is determined to be within the geographic area, a member-specific admittance code is generated for an event within the geographic area, and the location-based invitation is sent with the member-specific admittance code to the remote computing device.

In some embodiments, the invention provides a method including a server that receives a request for generation of an electronic message. The request is generated by the remote user by scanning, with a mobile computing device of the remote user, a graphic from a visual medium, wherein the graphic encodes a message identifier, by decoding, with the mobile computing device, the graphic into a digital identifier, and by forming the request including the digital identifier. The server receives the recipient information from the mobile computing device that identifies a recipient. The server also generates the electronic message according to the request, and sends the electronic message to the recipient.

In some embodiments, the invention provides a method that includes scanning, with a mobile computing device of the remote user, a graphic from a visual medium, wherein the graphic encodes a message identifier. The mobile computing device decodes the graphic into a digital identifier. The method also includes forming a request for generation of an electronic message including the digital identifier. The request and recipient information that identifies a recipient is sent to a server. In response to the request, the server generates an electronic message based on the digital identifier and sends the electronic message to the recipient.

In some embodiments, the invention provides a method including a server that generates a web page for a user. The web page is part of a social networking website that interconnects members, including the user, with each other based on an association request and confirmation process. The server further receives a media file from a user for resale by the website to the members. The media file has a sale price assigned for use in an electronic greeting card. The server receives apportionment information that indicates a first portion of the sale price that is to be provided to another member of the website upon a sale of the media and a second portion of the sale price that is to be provided to the user upon the sale of the media. The method further includes receiving, from a first member of the social networking website, an electronic greeting card selection, recipient information identifying a recipient, and a selection of the media file for inclusion with the electronic greeting card. Funds are also received from the first member. The funds are then provided to the another member and the user according to the apportionment information. The electronic greeting card with at least one of the media and a link to the media is generated and sent to the recipient.

Other embodiments of the invention include portions of the above embodiments, combinations of the above embodiments, and combinations of portions of the above embodiments. Other embodiments and aspects of the invention will become apparent by consideration of the detailed description and accompanying drawings.

### BRIEF DESCRIPTION OF THE DRAWINGS

FIG. 1 depicts a system for generating an electronic greeting card according to embodiments of the invention.

FIG. 2 illustrates an electronic greeting card server and databases.

FIGS. 3-5b further illustrate exemplary databases of FIG. 2.

FIGS. 6a-b depict a method for generating an exemplary electronic greeting card including media according to embodiments of the invention.

FIGS. 7-9 illustrate webpages of an exemplary electronic greeting card website generated by the server of FIG. 2.

FIG. 10 illustrates a calendar used by the server of FIG. 2.

FIG. 11 depicts an electronic greeting card assembly and meta data according to embodiments of the invention.

FIG. 12 depicts a greeting card generated by the server of FIG. 2.

FIG. 13 depicts a portable user/client device.

FIG. 14 depicts another system for generating an electronic greeting card according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Electronic greeting cards (“e-cards”) provide an option for sending a message to a recipient without needing to visit a “brick-and-mortar” establishment to purchase a card, purchase postage, and use a physical mail delivery system (e.g., the U.S. Postal Service). E-cards also provide nearly instantaneous delivery of greetings and messages to intended recipients from the convenience of a sender's home or office via a computer.

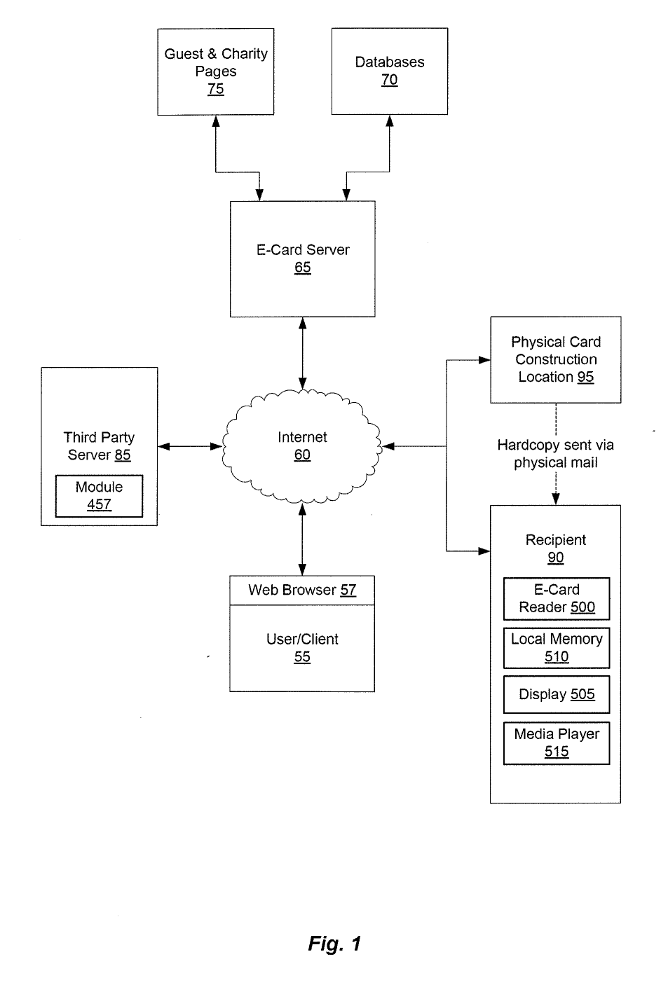

FIG. 1 depicts an e-card generation system 50 including a user computer 55, the Internet 60, and an e-card server 65. The server 65 is coupled to databases 70 and guest pages database 75. In some systems, the components of FIG. 1 are coupled via one or more networks, such as a local area network, wide area network, cellular network, and/or other types of networks, in addition to or in place of the Internet 60.

At a high-level, one method of operation includes a user at a user computer 55 inputting card selection information to the server 65 via a web browser 57 and the Internet 60. The server 65 uses the card selection information and accesses at least one of the databases 70 and a third party server 85 to generate an e-card including attached or embedded media. Exemplary media include music, graphic, video, electronic book files. The e-card is then provided either to the recipient computer 90 (e.g., via email) or sent to a physical card construction location 95. The physical card construction location 95 prints a hard copy of the received electronic greeting card and stores the attached electronic media on a portable storage media (e.g., a compact disc, flash drive, memory stick, etc.). The portable storage media is attached to the hard copy of the e-card and both are physically mailed to one or more recipients (e.g., the user of the recipient computer 90 or others). The portable storage media can be distinct from or alternatively incorporated with the hard copy to play upon opening. The e-card may be sent to the physical card construction location 95 with embedded code limiting the number of times that the e-card may be reproduced.

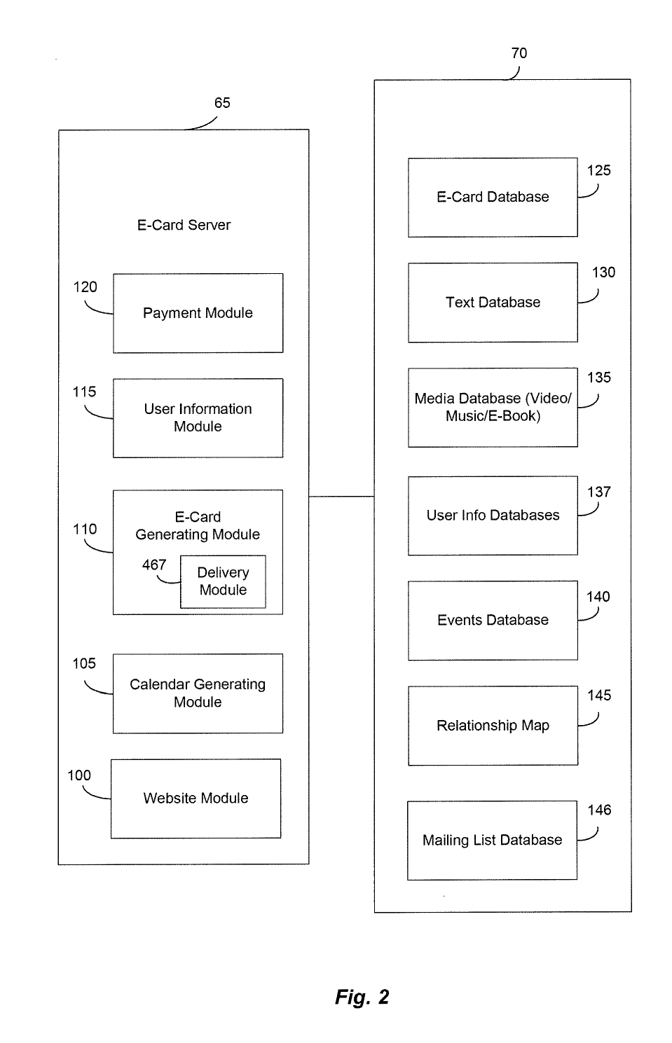

FIG. 2 depicts the server 65 and databases 70 in more detail. The server 65 includes a webpage module 100, calendar generating module 105, e-card generating module 110, user information module 115, and payment module 120. In some constructions, one or more of the modules or a portion thereof are located on a third party server 85.

The webpage module 100 generates webpage data for output to the web browser 57. For instance, the web browser 57 receives webpage data generated by webpage module 100 and displays the webpage data on a user computer 55. In some implementations, a portion of the webpage data is stored locally at user computer 55 from previous webpage data transfers and, therefore, an updating portion of webpage data is sent from server 65 to complement or overwrite the webpage data already stored on the user computer 55. Generally, at least a portion of the webpage data is generated “on-the-fly” after a user request. For instance, as will be explained in more detail below, the webpage data may be customized to a particular user and/or date before being output to the web browser 57.

The calendar generating module 105 generates calendar data and outputs the calendar data to the webpage module 100 for use in generating webpage data. As will be described in more detail below, the calendar data is used to form a calendar on the webpage including events and other information. In some systems, the calendar generating module 105 generates and stores calendar data periodically such that, upon a user request for webpage data, the calendar data is retrieved from a memory and sent to the webpage module 100. In other embodiments, the calendar generating module 105 generates at least a portion of the calendar data on-the-fly after a user request for webpage data via the web browser 57.

The e-card generating module 110 generates e-cards based on selection information received from the user computer 55 via the Internet 60. In some systems, e-card generating module 110 retrieves pre-generated e-cards from memory (e.g., from an e-card database 125). In some systems, e-card generating module 110 generates an e-card based on data retrieved from multiple databases within databases 70. For instance, the e-card generating module 110 generates an e-card based on retrieving and combining an e-card template from e-card database 125, lyrics from text database 130, and a music file from media database 135.

User information module 115 collects, analyzes, verifies, and stores user information. For instance, user information module 115 is operable to store user login and password information, as well as account level information, in the user information database 137. The user information module 115 compares user-entered login and password information from the web browser 57 with the stored information to verify the identity of a user at user computer 55. The user information module 115 is also operable to store user-entered preferences and to analyze user selection information. Through analysis, the user information module 115 identifies purchase and selection trends of the user to generate future purchase and selection suggestions. For instance, if a user purchases an e-card related to a particular artist or charity, the user information module 115 is operable to store the artist or charity name and/or characteristics thereof, and later cause the e-card server 65 to suggest another e-card related to the artist or charity to the user. The trend data and other analyzed data is used for other user customization actions, as will be described in more detail below.

The payment module 120 carries out user purchases. For instance, the payment module 120 receives user payment information (e.g., credit card information) entered by the user via web browser 57. The payment module 120 interacts with the third party server 85 (e.g., a credit card company server) to complete the transaction. Thereafter, a confirmation is sent to the web browser 57 to indicate to the user that the transaction completed.

The databases 70 include the e-card database 125, a text database 130, a media database 135, the user information database 137, an events database 140, and a relationship map 145. The databases 70, similar to the guest pages database 75, are coupled to the server 65 via a data link. In some systems the data link is a direct wired or wireless coupling. In other embodiments, the data link is a local network connection, which can include wired and wireless connections. In still other systems, the server 65 is connected to the databases 70 using a non-local network, such as the Internet 60 (a construction not depicted in FIG. 1). This construction may also include local network connections between the server 65 and databases 70. Each of the databases within databases 70 includes an addressable memory, such as a hard disc or other medium able to store and retrieve digital information. In some embodiments, all or a portion of the databases within databases 70 are stored in a single memory device. The databases 70 also include software for storing received data, searching stored data, receiving data requests, retrieving the requested data, and outputting the data to the requester or other appropriate recipient. In some systems, databases in databases 70 are combined. For instance, text database 130 and media database 135 are combined into a single database.

The e-card database 125 includes e-card templates that are used to form e-cards by the e-card generating module 110. The e-card templates include various levels of customizable elements. For instance, in some e-card templates, the only customizable portion is the sender name and receiver name. In another instance, a blank e-card template is almost entirely customizable including customizable size, color, message, lyrics and scripts, media attachments, etc.

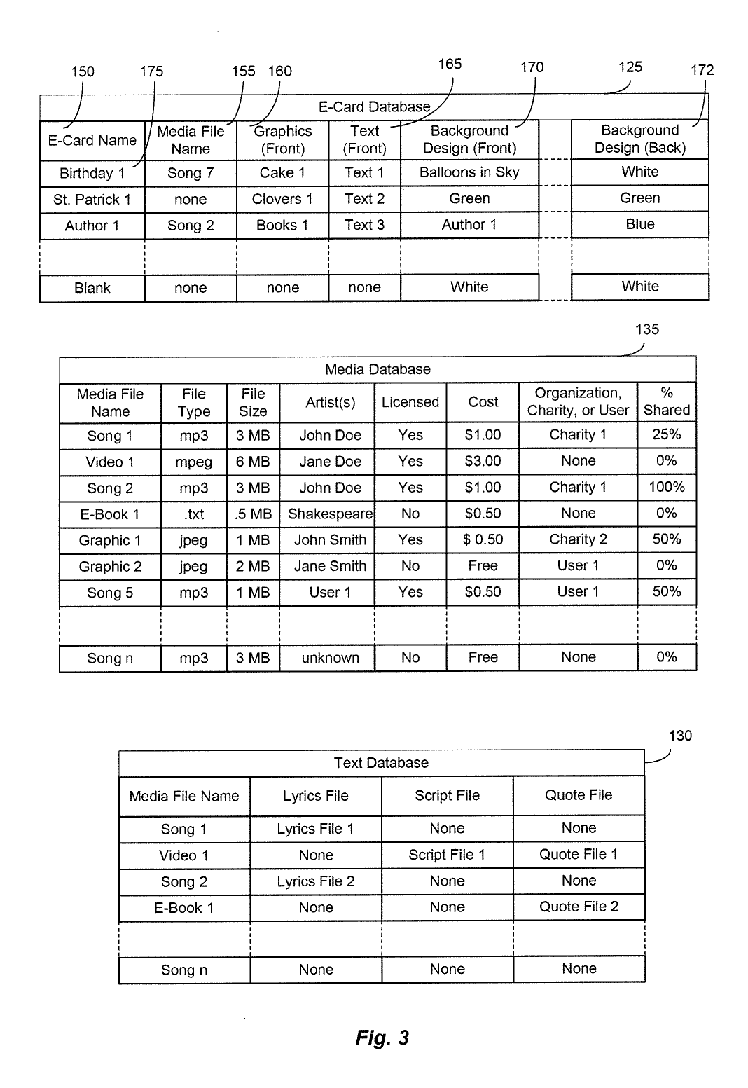

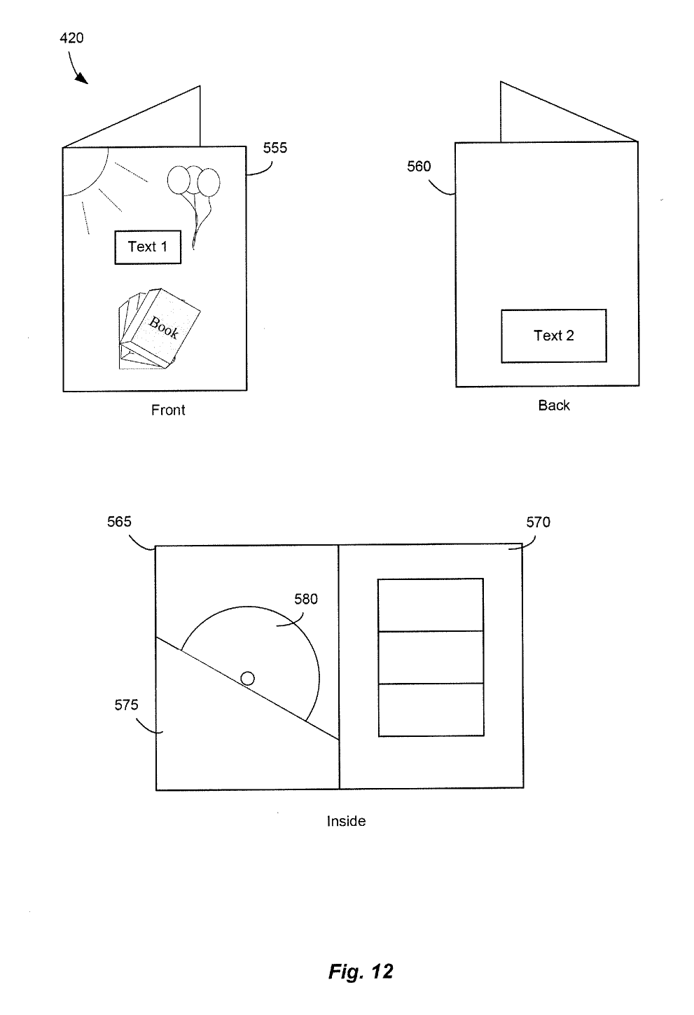

FIG. 3 depicts one exemplary construction of the e-card database 125. The e-card database 125 includes an e-card name column 150, media file name column 155, graphics (front) column 160, text (front) column 165, background design (front) column 170, additional columns not shown (as indicated by dashed lines), and background design (back) column 177. Each e-card template is assigned a row of the e-card database 125. E-card template 175 is titled “birthday 1” and includes a media file “Song 7.” The front of the e-card includes graphics file “books 1,” text file “text 1,” and a background design “Balloons in Sky” (see, e.g., FIG. 12). The back of the card includes a “white” background design. Although not shown in e-card database 125 depicted in FIG. 3, each portion of the card, e.g., the front, inside left, inside right, and back, includes one or more graphics columns, text columns, and background design columns. Additionally, other characteristics may be associated with each e-card in the e-card database 125, such as related music/movie genre (e.g., rock, pop, country, classical, horror, comedy, etc.), card genre (funny, serious, etc.), male/female recipient, male/female user, adult's card, children's card, holiday card, birthday card, religious event card, political card, etc.

In some implementations, users, charities, artists, or other organizations are able to create their own e-card template and, via server 65, store it to the e-card database 125. In some implementations, the e-card creator receives a share of proceeds from purchases or use of the created e-cards. For instance, an e-card created by a first creator is associated with the first creator via the e-card database 125. Additionally, a percentage value is stored (indicating the creator's share of the proceeds) and account information (where a share of the proceeds is to be credited) are associated with the e-card. In some systems, the account information specifies an account with the e-card website, an unrelated account (such as at a financial institution), an online account (such as PayPal™), or a particular organization or charity. In some instances, text is added to the e-card (e.g., at the bottom) or physical card (e.g., on the back) indicating that a charitable donation was made through purchase of the particular e-card or physical card. In some instances, textual artist and/or licensing information for media included in the e-card or physical card is added to the e-card or physical card.

In some systems, some e-cards include an invitation template. For instance, types of e-cards include a wedding invitation or birthday invitation. Such e-cards may include an “RSVP” button or link for informing the user whether the recipient 90 plans to attend the event to which they were invited.

In some systems, e-cards within the e-card database 125 have restrictions on their use. For instance, certain e-cards are specified as limited edition, whereby only a certain amount of e-cards are allowed to be produced by the e-card website or particular e-cards are only available during a certain time window (e.g., one hour, one day, one week, a holiday period, etc.). Another restriction selectively applied to e-cards is to only enable certain users to purchase or use particular e-cards. For instance, particular e-cards may only be available to users that have been associated with the e-card website for a certain amount of time or users that have spent a certain amount of money with the e-card website. Other restrictions for particular e-cards are contemplated by embodiments of the invention.

The media database 135 includes licensed and unlicensed media files, such as video files, music files, electronic books (“e-books”), and graphic files. License holders include business entities of various sizes, as well as individuals. In some instances, multiple license holders share rights or have distinct rights related to a particular media file. Each media file is associated with particular information. For instance, for a video file, the associated information includes one or more of file name, file type, file size, licensed/unlicensed, organization or charity, music genre (rock, pop, hip hop, classical, etc.), movie genre (horror, comedy, etc.), video/song length, video quality, etc. Licensed/unlicensed indicates whether the media includes content that has been or must be licensed for use. The organization or charity column indicates whether the purchase of the media will result in an apportionment of funds between the user and the listed organization or charity (e.g., a portion of funds being a charitable donation) through the server 65, as will be described in more detail below. In some constructions, the media database 135 is separated by media type into a database for music, a database for video, a database for graphics, and a database for e-books. In some constructions, additional columns are used to associate additional charities and their respective shares of the proceeds. In some constructions, rather than a charity being listed, a business partner, such as a promotional organization, receives a portion of the proceeds. For instance, a promotional organization, will receive a portion of proceeds received for purchase/use of the media file in exchange for promoting a particular media file on the e-card website or elsewhere. Furthermore, additional columns specifically describe where each portion or additional portions of the proceeds are to be forwarded (e.g., the percentage share and the account information) are associated with media or e-cards in their respective databases.

In some implementations, users have the option to store user-generated media within the media database 135. For instance, a user is able to capture media (e.g., audio or video) using user equipment (e.g., a home computer, microphone, camera, sophisticated recording equipment and software, etc.), then upload the media to the media database 135 via the e-card website. In some implementations, a third party website, either by direction of a user or a third party website operator, supplies media to the media database 135. For instance, a user may upload media to a third party website and, at a later time, upload a copy of the media to the media database 135 for use in e-cards from the third party website. For example, the e-card website enables browsing of media on the third party website and selection of media to be uploaded from the third party website to the media database 135 or attached directly to an e-card (without being separately saved in the media database 135). In some implementations, users, charities, organizations, or others are associated with the media that they supply or others supply on their behalf to media database 135 for sharing proceeds, similar to user-created e-cards.

A table representing one construction of the media database 135 is depicted in FIG. 3. Each media file occupies one row of the table, which is indexed using the media file name (e.g., “Song 1”). Song 1 is in mp3 format, is 3 MB in size, and was performed by John Doe. Although the artist(s) column 185 only lists John Doe, in some constructions, additional artists are included in this or in another artist column. For instance, Song 1 may also be associated with a particular producer, lyrics writer, composer, etc. Song 1 is also licensed media and a fee of $1.00, for example, is charged to use it in an e-card. If purchased for use in an e-card, the licensor has agreed to provide 25% of the proceeds to Charity 1. The licensor of Video 1, in contrast, has not agreed to share proceeds with another organization.

In some implementations, artists may record an optional introduction to be played along with their related media or e-card. For instance, a supplemental recording may include an artist saying, “Hey, it's Bruce, just want to wish you a happy birthday” to preface a recording of a song related to a birthday. In some instances, an additional fee may be charged for use of the introduction, with proceeds going to the artist or to a charity chosen by the artist.

The text database 130 includes lyrics, scripts, and quotes associated with media stored in media database. One construction of the text database 130 is depicted in FIG. 3. The text database 130 is indexable using a media file name that is, for example, retrieved from the media database 135. After the text database 130 receives a media file name, the text database 130 returns the associated lyrics file or script file associated with the media file. Lyrics files and scripts files are, for instance, a text file. In some constructions, the text database 130 combines the lyrics file column, script file column, and quotes file column into a single file column. A quotes file includes portions of text often associated with the related media. For instance, the quotes file includes a famous quote from a movie, book, or song.

In some implementations, a price attribute is associated with one or more of select e-cards in the e-card database 125, select media in the media database 135, select lyrics files, select script files, and select quotes files in the text database 130. The price attribute reflects the price for using the associated element in an e-card. For instance, use of a particular e-card template may cost $0.75, use of an audio file may cost $1.00, and use of associated lyrics may cost $0.50. These prices are merely exemplary. In some implementations, an e-card template associated with a particular audio file and lyrics are bundled for a reduced price relative to a user-created e-card that modifies the same e-card template to include a different audio file and lyrics file. The price attribute may be included in a single price column within one or more of the e-card database 125, media database 135, and text database 130, or it may be separated into multiple price attribute columns within each database to separate the different components thereof (e.g., markup, license fee, etc.).

In some constructions, particular e-cards are auctioned, whereby users submit bids and the user with the highest bid purchases the e-card at their bid price. In some constructions, multiple auction winners are allowed whereby the top bidders (e.g., top ten, top 100 bidders, etc.) are able to purchase the e-card. Minimum prices may be used to require the winning bidders to be above a particular price threshold.

In some implementations, the prices associated with particular e-cards and/or media are conditioned on time of purchase and/or quantity of purchase. Via conditions, a particular e-card or media file is available for free or a reduced price for a promotional time period (e.g., a launch week) and/or for the particular quantity purchased (e.g., the first 1,000 copies). In some implementations, a license holder restricts the number of their e-card or media file that is available per customer for free or reduced price. For example, a particular user is limited to sending three copies of a particular media file, so that a single user does not send all 1,000 free media files. The e-card sent with the promotional media file may include a notice to that effect so that the recipient is informed of the promotion and is also able to send the promotional media file for free or at a reduced price.

In some constructions, additional attributes are associated with particular e-cards, media files, lyrics files, and/or scripts files for additional sorting and searching functionality. For instance, particular files within the databases 70 may be associated with a particular brand or line within a brand having related characteristics.

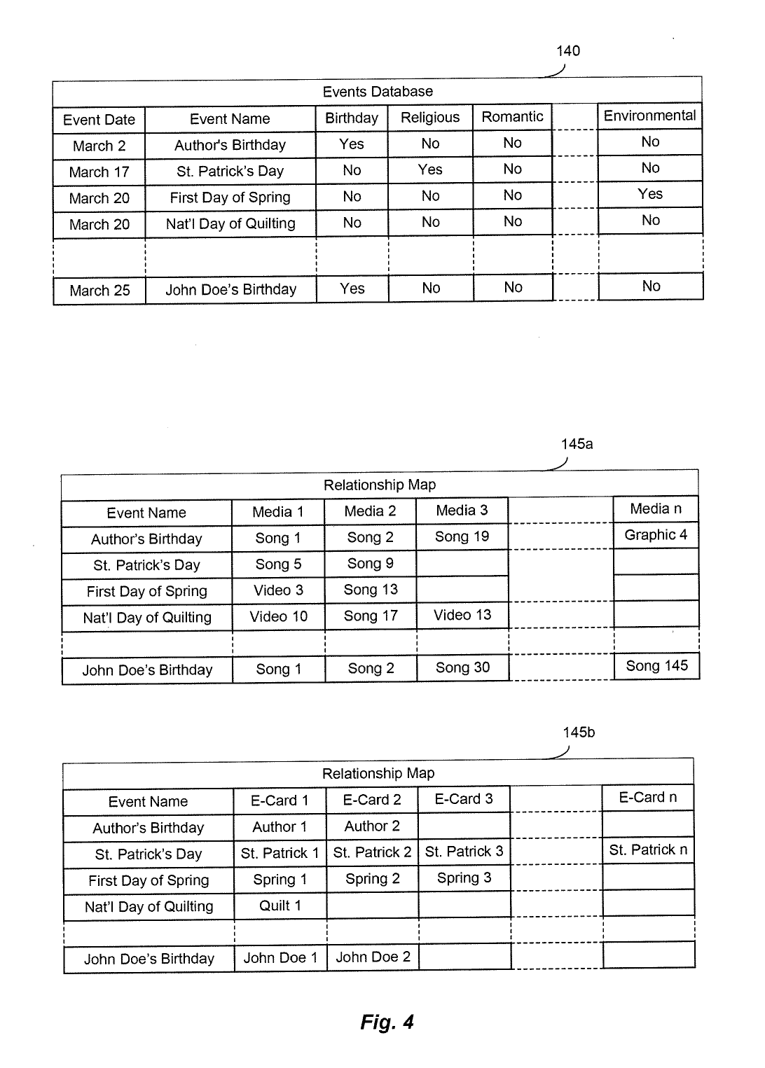

In some constructions, the events database 140 stores events data based on calendar dates. The events database 140 depicted in FIG. 4 includes one event per row and is organized by event date. For example, one row is for Author's Birthday, which is on March 2. Each event is also categorized to aid in searching the events database 140. For example, Author's birthday is categorized as a birthday, but not religious, romantic, or environmental. The categories listed in the events database 140 are exemplary and additional categorizations are contemplated by embodiments of the invention.

In some constructions, the events database 140 is indexable using a date. For instance, after the events database 140 receives a date (e.g., March 20), the requester is sent those event names and their associated data in the same row that occur on the date. In some implementations, if a requester sent March 20 to the events database 140, the events database 140 would return both the first day of spring event data and the national day of quilting data. The number of results (events) returned may be limited or varied in different implementations. In some implementations, the event date includes a year such that particular anniversaries, non-annual events, and annual events that are on different dates depending on the year are represented. For example, the 25^{th} anniversary of National Day of Quilting, presidential inaugurations, and Thanksgiving, respectively.

In some constructions, e-card database 125, text database 130, the media database 135, and events database 140 also store usage data related to each item found within each database. For instance, the databases also store the quantity and/or frequency of purchases and/or previews of a particular item, such as a song or e-card template. This usage data is stored in a separate usage database (not shown), within each respective database, or a combination thereof. Additionally, in some constructions, the e-card database 125, text database 130, the media database 135, and events database 140 also store text such as tag or description data. The tag or description data provides additional text data for use in searching the databases.

The relationship map 145 associates event names with particular media files and/or e-card templates. FIG. 4 depicts two exemplary relationship maps 145a and 145b according to some embodiments of the invention; however, in other embodiments, the relationship maps 145a and 145b are combined into a single map. Relationship maps 145a and 145b include one row per event name and are indexable using the event name. For instance, upon receiving an event name (e.g., Author's Birthday), the relationship map 145a returns a list of associated media (e.g., Song 1, Song 2, Song 19, and Song 19). The media and e-cards are associated with an event name in the relationship maps 145a and 145b, respectively, for a number of reasons including their content, associated charity(ies), and associated artist(s). For example, Song 1 and Song 2 are associated with Author's Birthday because each is associated with Charity 1 (see media database 135), which is an organization dedicated to children's reading programs. Song 19 is associated with Author's Birthday because the content of the song is about Author or his books. Graphic 4 is associated with Author's Birthday because a character from an Author book is illustrated in Graphic 4. Similarly, with respect to the first day of spring, Video 3 depicts a blooming flower and Song 13 includes lyrics related to the spring season.

The relationship map 145 is populated in a variety of ways. In some implementations, artists or licensors of media suggest the association between one of their media files and a particular event or category of events (e.g., environmental or romantic). In some embodiments, a charity suggests an association with a particular event or category of events, and one or more media files associated with the particular charity (see media database 135) are then associated with the event. In some implementations, a system administrator manually enters associations. In some implementations, users suggest associations by accessing the server 65 via the web browser 57. In some implementations, the server 65 recognizes trends in user created e-cards and enters associations in the relationship map 145 based on the trend. For instance, if Song 34 is selected and attached to an e-card related to a particular event (e.g., St. Patrick's Day) a certain number of instances in a set time (e.g., 100 uses within two days), the server 65 causes the relationship map 145 to add an association of Song 34 to St. Patrick's Day. Other methods of populating the relationship map 145 are contemplated by embodiments of the invention.

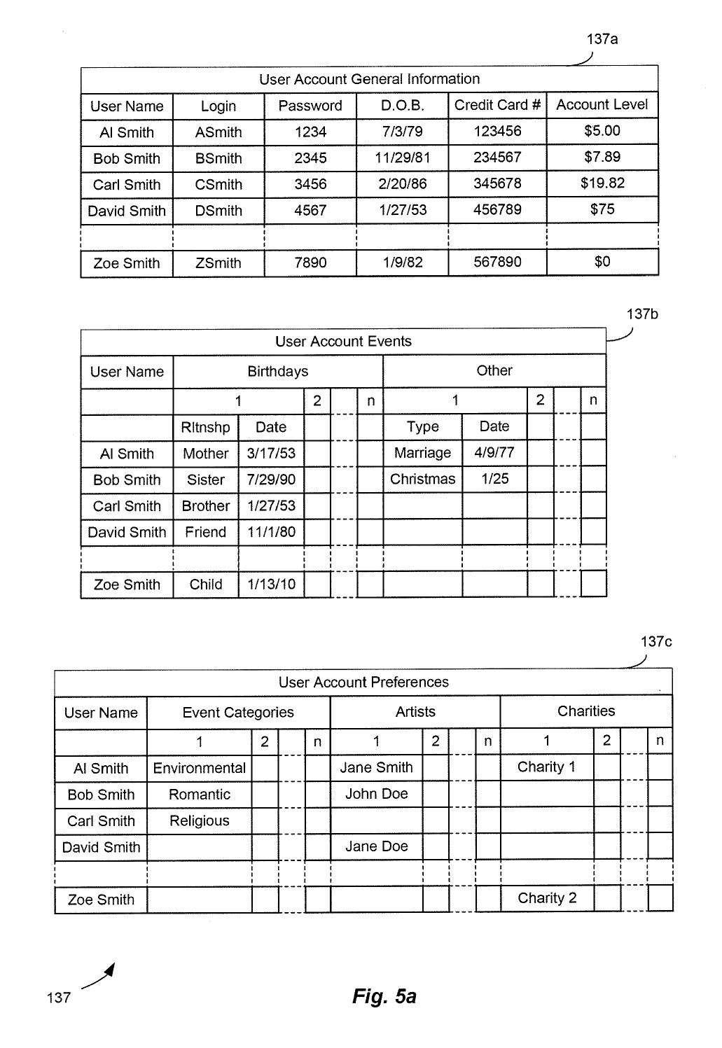

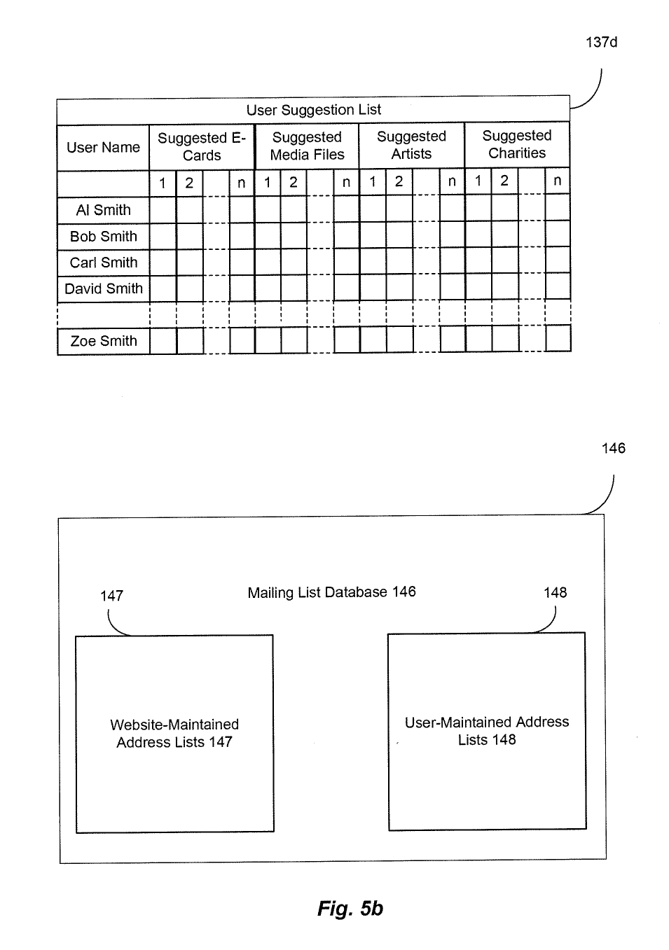

A construction of the user information database 137 is depicted in FIGS. 5a and 5b. The user information database 137 includes four sub-databases: user account general information database 137a, user account events database 137b, user account preferences database 137c, and user suggestion list 137d. Although the databases 137a-d are depicted as separate entities, in some embodiments, one or more of the databases 137a-d are combined into a single database. In other embodiments, databases 137a-d are separated into more databases (e.g., a user birthday database, user anniversary database, user artists database, user charities database, etc.).

User account general information database 137a includes a user name, user login, user password, user date of birth (also referred to as “d.o.b.”), user payment information (e.g., credit card information), and user account level information. The server 65, in particular, the user information module 115, verifies user login and password information using the user account general information database 137a. The user account level information stores the level of credit that the user has with the e-card website. For instance, upon redeeming a gift card or through a purchasing transaction, a user has a store credit for use on e-cards, media, or other items purchasable via the e-card website. Store credit can be a monetary amount (e.g., $5.00) or quantity of an item (e.g., two e-cards or one audio file). In some implementations, the payment module 120 updates the user account level information.

The user account events database 137b includes event data stored, for example, by the user. For example, Al Smith has stored his mother's birthday information and his marriage anniversary information. The birthday information can include relationship information (i.e., how the individual identified is related to the user) and the birth date of the individual. Similar date and relationship information or other descriptive information is stored with each event in the user account events database 137b.

The user account preferences database 137c stores information about the types of events, artists, charities, and genres (e.g., music, movie, card, etc.) in which the user is interested. In some embodiments of the invention, additional user preferences are stored. For example, the type of music or type of charity (instead of specific instances of each) is included. In some implementations, the user account preferences database 137c is populated by the user, the user information module 115 based on past purchases, the user information module 115 based on browsing records, or other methods, or a combination thereof.

The data stored within the user suggestions list 137d includes one or more of e-cards, media, artists, and charities associated with previous user activity on the website or user information otherwise obtained. Some information stored within user suggestions list 137d may overlap or closely relate with information stored in user account preferences database 137c. Based on a user's prior purchase of an e-card including, e.g., Song 2 by John Doe, songs 3-10 also by John Doe would be added to the user suggestions list 137d for suggestion during future e-card creation by the same user. Similarly, based on a user's purchase of an e-card that resulted in a donation to Charity 1, other e-cards that result in donations to Charity 1 would be suggested when the user is browsing the website or creating an e-card. Suggested e-cards and artists are similarly added to the user suggestions list 137d based on their relation to a user's earlier e-card website browsing, e-card purchasing, and/or information stored in the user account preferences database 137c (e.g., preferred music, movie, and card genre).

In some implementations, the server 65 generates emails for a particular user based on the information within the user suggestions list 137d. For instance, if a new media file created by John Doe is uploaded to the media database 135, or if John Doe announces a new concert that will take place nearby the user's home, the server 65 is operable to generate and send an email or text message to the user informing the user of this information. Additionally, links to further information, to ticket purchasing websites, and/or to the e-card website may be provided within the email. In some implementations, the artist, individual or organization pays a fee for such an informational email to be sent to one or more users that are associated with the artist, individual, or organization via the user suggestions list 137d.

The server 65 interacts with the user account events database 137b, user account preferences database 137c, and user suggestions list 137d to, for instance, send email and/or text message reminders of upcoming events or suggestions for e-cards that the user may be interested in purchasing. A user is able to update his or her information in the user account events database 137b and user account preferences database 137c. Additionally, the server 65 (e.g., the user information module 115) is also operable to update the user's information in the user account events database 137b and user account preferences database 137c based on past e-cards created by the user, past browsing activity on the e-card webpages, and other user information.

FIG. 5b depicts the mailing list database 146 according to one construction of the system. The mailing list database 146 includes website-maintained address lists 147 and user-maintained address lists 148. The address lists 147 and 148 include at least one of email addresses and physical mailing addresses. The website maintained address lists 147 include address lists stored in the mailing list database 146 by a website authorized personnel, such as an administrator (i.e., not by general users). The website maintained address lists 147 include one or more lists of addresses that are, for instance, licensable or purchasable by users of the website. For instance, an artist or organization may wish to send an e-card including a new song (audio file or video file) to executives of one or more music labels, a particular advertising agency, or other group of people whose addresses are stored in a list within the website maintained address lists 147. If the user meets certain standards set by the website and pays a particular fee, the user is able to send an e-card to the members of the list. The fee may be variable based on the list chosen. The transaction is handled by the payment module 120 similar to other e-card purchases, but the additional address list fee is added to the purchase price.

In an additional example, an artist, advertising organization, or other organization, sends an e-card including a new media file to a particular demographic of users of the e-card website (e.g., males aged 20-30, married females aged 35-45 that are interested in the environment, etc.). Based on information in the user information databases 137, the users that meet the desired demographics are grouped to form an address list within the website maintained address lists 147. These address lists are generated “on-the-fly” upon user request in some implementations. In other implementations, the website maintained address lists 147 constantly update lists stored therein based on changing user information within user information databases 137. If the user meets certain standards set by the website and pays a particular fee, the user is able to send an e-card to the members of the demographic list. The fee may be variable based on the demographic list chosen. The transaction is handled by the payment module 120 similar to other e-card purchases, but the additional address list fee is added to the purchase price.

The user maintained address lists 148 include lists of addresses (physical addresses, email addresses, or a combination thereof) maintained by users. Exemplary address lists maintained by the user include, for example, a friends list, a family list, a co-worker list, a business contacts list, hybrids thereof, or other lists as created by the particular user. By way of the stored address lists in the user maintained address lists 148, the user is able to include all members of a particular list as recipients by referring to the list as, for instance, the recipient information for an e-card. In some instances, address lists are imported or synchronized with address lists of the user maintained for software programs (e.g., email programs) and devices (e.g., mobile phones).

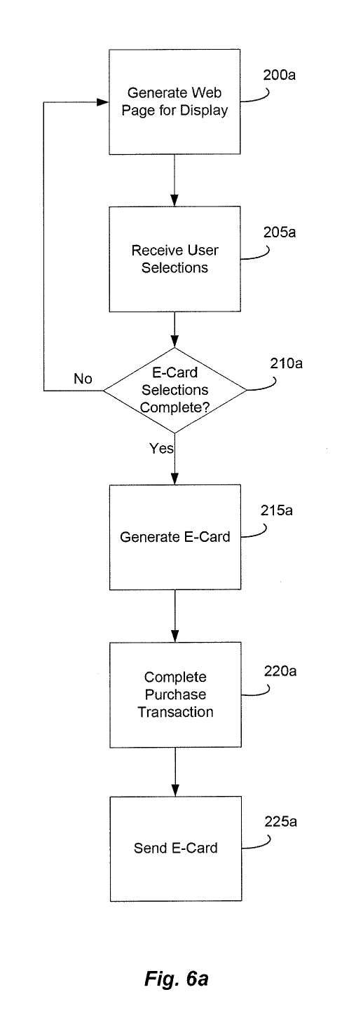

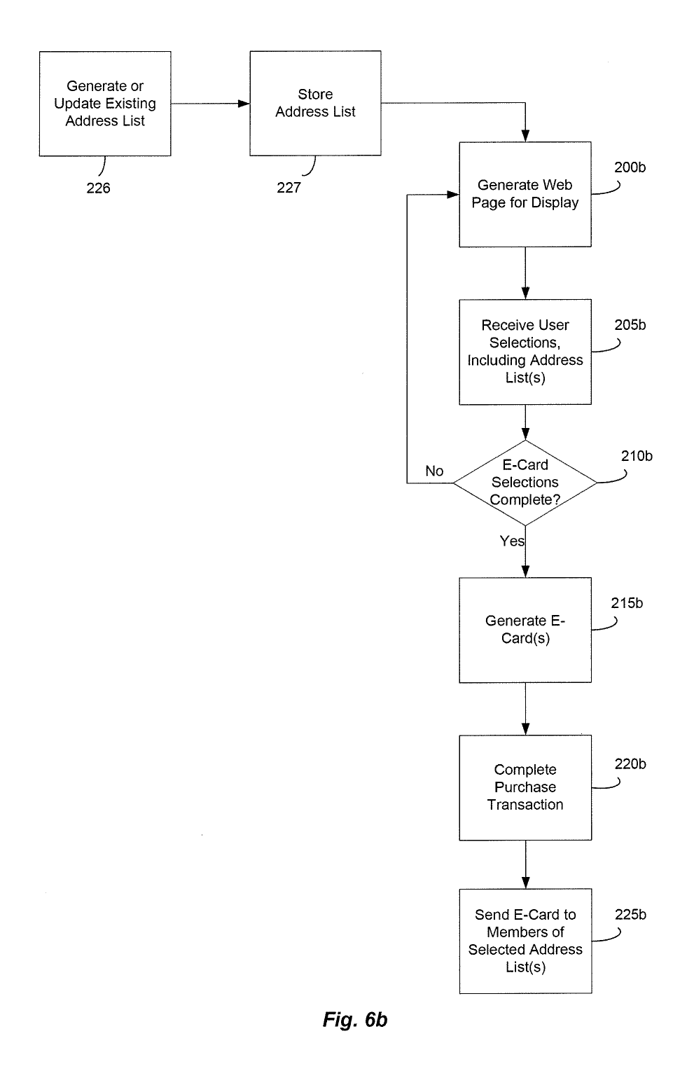

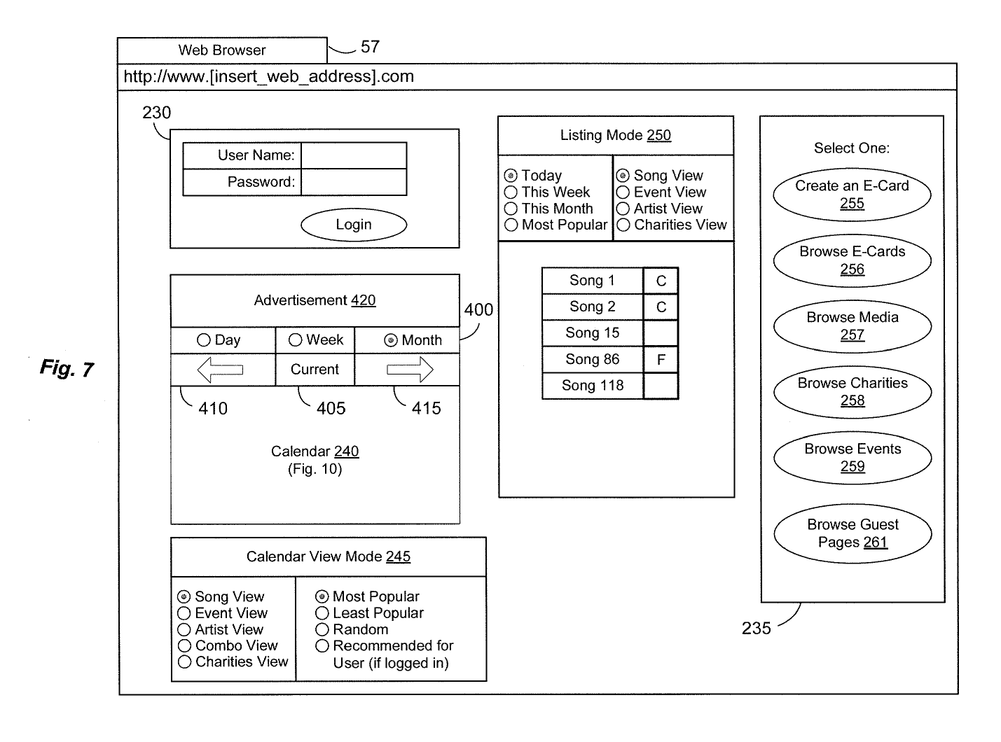

FIG. 6a depicts a method of generating an e-card according to embodiments of the invention. In step 200a, the server 65, in particular, the webpage module 100, generates a webpage data for display in a web browser. The webpage data is sent to the user's web browser, for instance, over the Internet 60. Once received, the webpage data is displayed in the web browser or e-card application. For instance, FIG. 7 depicts an exemplary home page displayed in the web browser 57 based on the webpage data generated in step 200a.

In step 205a, the user inputs information via the user computer 55 to the server 65. The user interacts with the server 65 via the web browser 57 and the server responds to the user-entered information and outputs updated webpage data accordingly. The information entered by the user may include selection information (e.g., selection of an e-card template or media file or entering search criteria), commands (e.g., generate e-card or purchase e-card), and/or user information (e.g., login, password, or information for user information database 137). This interaction between the user, user computer 55, and server 65 is commonly referred to as “browsing.” Browsing the e-card website (used to refer to the webpage data collectively generated, stored, and output by the server 65) includes, among other things, logging into the website, creating e-cards, browsing e-cards, browsing media files, browsing charities, and browsing calendars. Steps 200a and 205a are repeated during this browsing period until, in step 210a, the server 65 receives the information necessary to generate an e-card, which may or may not include a specific generated e-card command from the user.

In step 215a, the server 65, in particular, the e-card generating module 110, generates an e-card based on the user information entered. After the e-card is generated, depending on the embodiment of the invention and the particular e-card generated, the user may be required to purchase the e-card. The server 65, in particular, the payment module 120, carries out the purchase transaction in step 220a. In step 225a, the e-card is sent by the server 65 to one of the recipient computer 90 or the physical card construction location 95.

FIG. 6b also depicts a method of generating an e-card according to embodiments of the invention. The method in FIG. 6b is similar to the method of FIG. 6a, but includes two additional steps 226 and 227. The method of FIG. 6b is a method of generating an e-card in which a mailing list, e.g., from mailing list database 146 is used. In step 226, a mailing list is generated or updated by either the website operator or a user. In step 227, the mailing list is stored in the appropriate website-maintained address list 147 or user-maintained address list 148, depending on the entity that generated or updated the mailing list being stored. Thereafter, steps 200b-225b are similar to steps 200a-225a depicted in FIG. 6a and described above, except that in step 205b the user selects a particular mailing list from the mailing list database 146 and in step 225b, the e-card is sent to the members of the mailing list selected in step 205b. Of course, the method of FIG. 6a also includes the ability for a user to select a mailing list and send an e-card to members of the selected list, but FIG. 6b particularly illustrates these steps.

As mentioned above, FIG. 7 depicts web browser 57 with one exemplary layout of the e-card website homepage 228. The homepage 228 includes a login section 230, a selection section 235, a calendar 240, a calendar view mode section 245, and a listing section 250. In some implementations, after a user logs on to the website using login section 230, which interacts with the server 65 to verify the user's identity as described above, the components of the website are updated with customized webpage data. In some implementations, cookies stored on the user computer 55 from a previous webpage visit are automatically used by the server 65 to verify the user's identity without requiring login actions. A user is also able to browse without logging in to the e-card website.

In some embodiments, the homepage 228 is customized for the particular user. For instance, the user is able to customize the homepage 228 such that each time he or she logs in to the server 65, particular settings of the calendar 240 and listing mode 250 are shown. Additionally, the server 65 may generate a custom homepage for a user based on user preferences stored in user account preferences database 137c. For instance, a user that prefers country music may have a homepage 228 that has country music-themed background images, a country music-based calender 240, and country songs listed in the area of the listing mode 250. A user that prefers hip hop music, however, would have a hip hop-themed homepage 228 generated.

The listing mode 250 displays songs, events, artists, or charities of the e-card website, which may be of a particular genre or otherwise customized to the user. Although the listing mode 250 depicts these items as a static list, in some embodiments, the list is a real time scroll of the top media or e-cards being purchased or used on the e-card website.

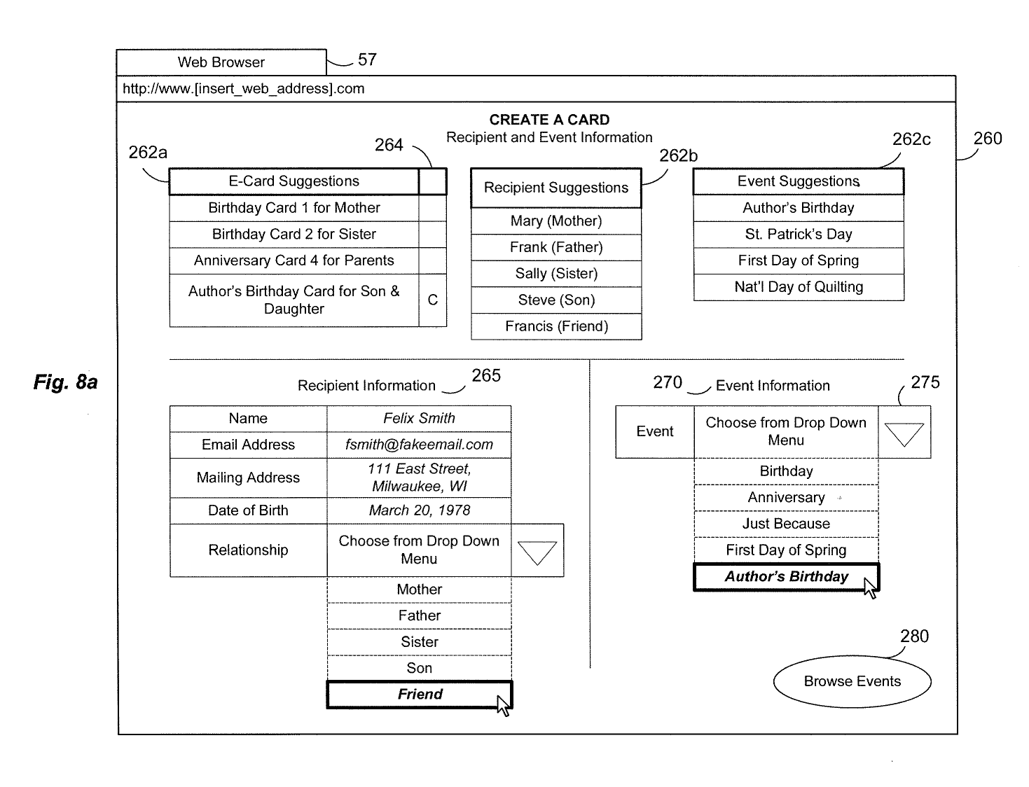

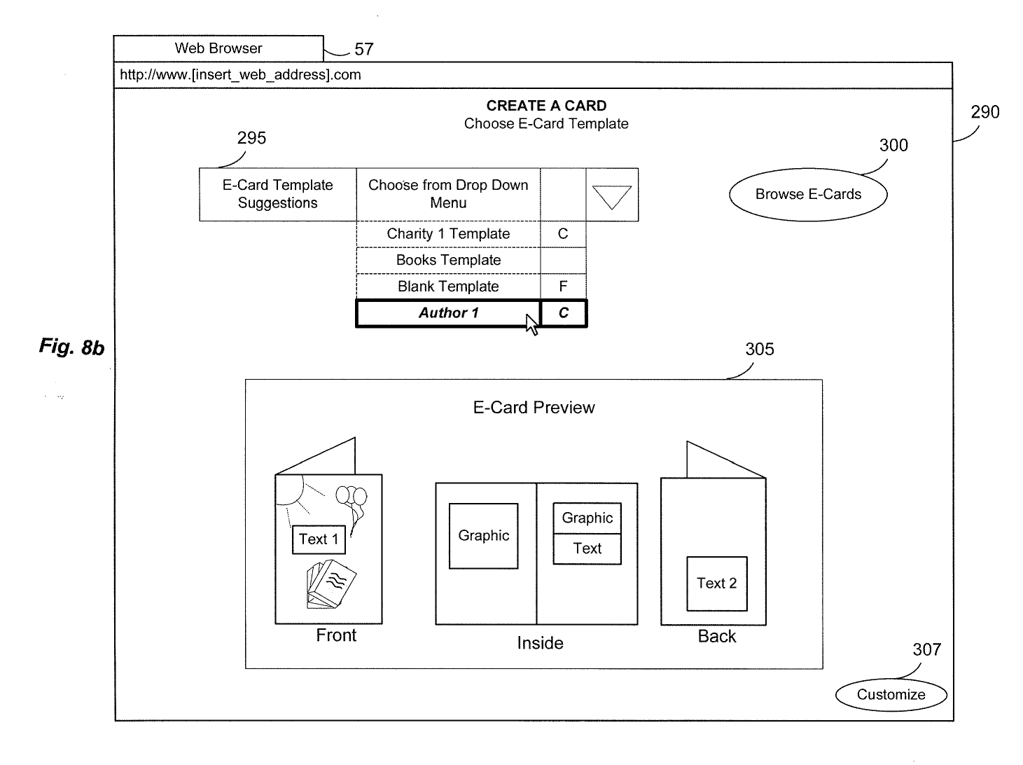

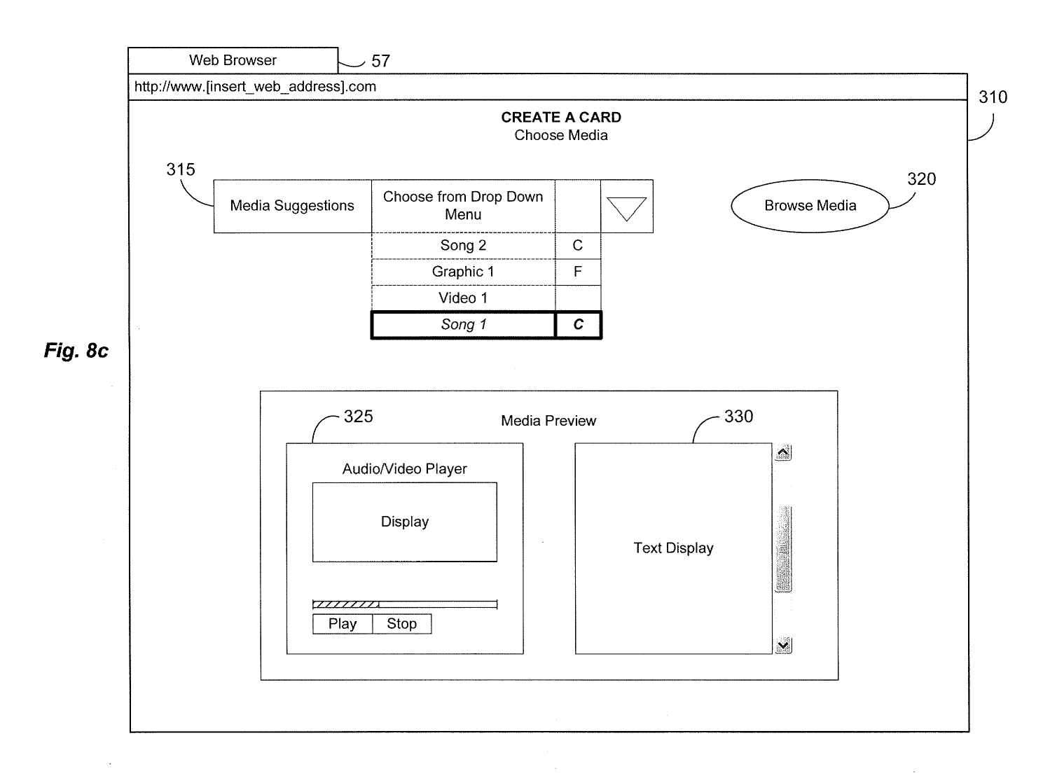

A user chooses a browsing option by selecting one of the following buttons in the selection section 235: create an e-card 255, browse e-cards 256, browse media 257, browse charities 258, browse events 259, and browse guest pages 261. If a user selects create an e-card 255, the user will interact with the e-card website to create an e-card. FIGS. 8a-c illustrate a portion of the various webpages used to create an e-card.

In FIG. 8a, the user inputs recipient and event information to the webpage 260. If the user is logged on, the server 65 may suggest possible e-cards, recipients, and events based on the current data and/or data stored in the user information database 137 (e.g., birthday card 1 for mother). In some implementations, some or all of the suggestions are chosen for display based on payments received by the website operator from the license holders of the suggested e-cards and/or media. In some implementations, an e-card suggestions list 262a also includes a column 264 for indicating additional information about the e-card. For instance, column 264 includes a “C” if the e-card is associated with a charity, an “F” if the e-card is free, an “S” if the e-card includes a song, and a “V” if the e-card includes a video. In some implementations, other naming conventions or the use of symbols (rather than letters) are used in column 264 or additional columns. Additionally, the column 264 or additional columns may be used to store additional information.

In some implementations, the suggestions are displayed in lists 262a-c, as shown in FIG. 8a. In other implementations, a drop-down list or other display method is used. If the user selects a suggested recipient or event, the server 65 fills in the recipient information 265 to the extent the information is available from the databases 70. If the user is not logged on or the user does not select a suggested item, the user enters the recipient information 265 manually. The text entered, either automatically or manually, is shown in italics in FIG. 8a. The recipient information includes some or all of the recipient's name, address (email or physical mailing address), birth date, and relation to user, among other information.

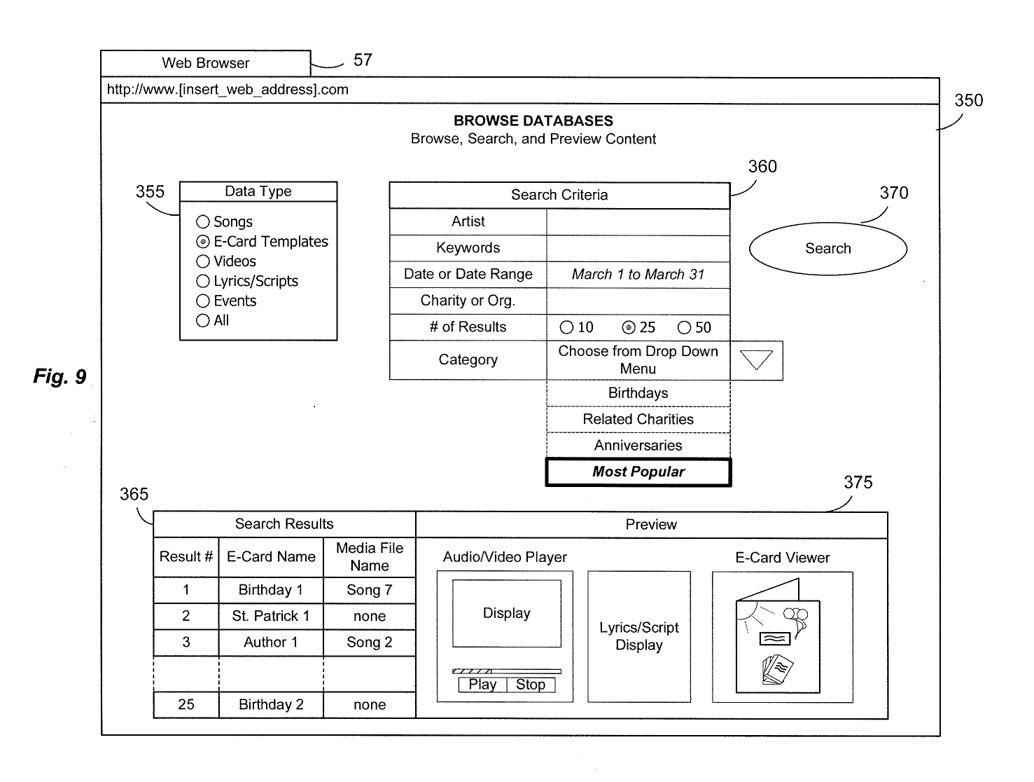

The user also inputs event information 270. For instance, the server is operable to send webpage data such that the web browser 57 displays a drop-down menu 275 or list of suggested events (e.g., birthday, anniversary, and events based on the current date). A browse events button 280 is also provided to enable the user to browse the events stored in the events database 140. For example, in some implementations, the website provides a database browsing interface for the events database (see, e.g., FIG. 9).

In some implementations, event information entered via drop-down menu 275 (or via additional radio buttons or other similar input means) is used by the server 65 to update the suggestions in lists 262a-c. For instance, selecting anniversary in the drop-down menu 275 causes the server 65 to update the e-card suggestions list 262a to include more anniversary cards, the recipient menu 262b to include the user's spouse, and event suggestions to include an anniversary item. The suggestions update may remove some or all of the items previously listed in lists 262a-c.

After receiving the recipient and event information, the user is presented with e-card template options in webpage 290, as shown in FIG. 8b. Based on the recipient and event information received, the server 65 generates a list of suggested e-card template options for use in the e-card drop-down menu 295. The server 65 generates the list by using the received recipient and event information to access the e-card database 125. For instance, if the event is a birthday, the server 65 is operable to send the “birthday” event name to the relationship map 145b, which returns associated e-card templates. A browse e-card templates button 300 is also provided to enable the user to browse the e-card templates stored in the e-card database 125 (see, e.g., FIG. 9).

In some implementations, the webpage 290 includes an e-card preview window 305. When an e-card template is selected from the e-card drop-down menu 295, a preview of the e-card template is generated by the server and displayed in the e-card preview window 305. If a particular e-card was selected from e-card suggestions list 262a, a preview is automatically displayed upon reaching the webpage 290 in some implementations. A user may select an e-card template and proceed to customization options by selecting the customize button 307.

After an e-card template is selected, the user is presented with customization options. For instance, the user is presented with media suggestions in a drop-down menu 315 to attach or embed in the e-card, as shown in webpage 310 of FIG. 8c. A browse media button 320 is also provided to enable the user to browse the media stored in the media database 135 (see, e.g., FIG. 9). Upon selection of media, the server 65 retrieves the media file and any associated lyrics or scripts files from the databases 70. The media file is loaded into the media player 325 for the user to preview the media. In some implementations, only a sample of the media file (e.g., 15 seconds) is available for preview. If the media file chosen is a graphics file, the graphic is displayed by the media player 325 at a full or reduced resolution or size. If a lyrics or scripts file is associated with the selected media file, the text is displayed in the lyrics/script display 330. For some e-cards, customization options are restricted or limited. For instance, certain e-cards have set graphics, messages, and attached media, and customization is limited to adding a recipient's name. Other levels of restriction are also associated with particular e-cards.

In some implementations, the media file and any associated lyrics or script files are automatically loaded into the media player 325 and text display 330 upon reaching the webpage 310. In particular, the automatic loading occurs if a particular e-card was selected from the e-card suggestions list 262a or an e-card template with an associated media file was selected. For example, if the e-card template “Birthday 1” was selected on webpage 290, Song 7 and any associated lyrics are automatically loaded. The e-card database 125 of FIG. 3 shows the association between the e-card template Birthday 1 and Song 7.

Additionally, although not shown, the user is able to enter text, adjust the e-card size, adjust the e-card colors, adjust the background, attach additional graphics, attach additional media, and make other card customizations as is understood in the art. In some implementations, a user uploads particular pictures or other media to be attached to the e-card for a one-time use (i.e., the created e-card will not be saved in the e-card database). These additional adjustments may occur via a different webpage (not shown). Thereafter, the server 65, in particular, the e-card generating module 110, generates an e-card for the user to preview before purchase (step 215a of FIG. 6a). The user is able to navigate back to steps 200a-210a and make alterations to earlier selections for the e-card (i.e., enter new e-card selection information via homepage 228, webpage 260, webpage 290, and webpage 310).

Once the user is satisfied with the generated e-card, the server proceeds to complete the purchase transaction in step 220a. If not specified in an earlier stage, the user selects the delivery method. Delivery method options include sending an e-card as an email (to an email address) and sending an e-card as a text message (to a phone number or other text message capable device). Additionally, the e-card is optionally sent to a physical card construction location 95, which generates and mails a physical card to a physical mailing address. The physical card is also optionally sent with physical copies of the media in separate tangible mediums. For instance, if an e-book is selected for an e-card, a hard copy of the book is provided along with the physical card or an electronic copy is provided on a digital storage device, such as a USB flash drive. If a video is selected for an e-card, the video is provided on a CD, DVD, USB flash drive, or the like. In some instances, the physical card construction location 95 also receives user input (e.g., via the e-card server) selecting particular postage designs or customized postage designs based on one or more user-provided image files. The user is also able to specify a delivery date or delivery date window (as physical mailing may be less precise). Thus, a user is able to pre-order e-cards and ensure a delivery at a later date.

FIG. 9 depicts a webpage 350, which enables a user to browse, search, and view/preview content within the databases 70 according to one embodiment of the invention. Some exemplary content that can be accessed via webpage 350 includes media in media database 135, events in events database 140, lyrics and scripts in text database 130, and e-card templates in e-card database 125. The webpage 350 includes a data type selection box 355, a search criteria box 360, and search results box 365. A user selects a data type, e.g., e-card templates, in the data type selection box 355.

Based on the user selection, the search criteria box 360 is updated to display the search criteria applicable to the particular data type. After selecting e-card templates in the data type selection box 355, the search criteria box 360 includes the following fields: artist, keywords, date or date range, number of results, and category. Although the category box is depicted as a drop-down menu, in some implementations, the category field may also receive user input such that the category field may be searched. In some implementations, additional or fewer search fields are listed, such as music genre, movie genre, and card genre. In still other implementations, the search criteria box includes all the possible search fields regardless of the selection of the data type. Additional search fields include media title (e.g., song title), year created, etc. In some implementations, the searchable data (e.g., e-cards, media, and lyrics) are associated with keywords in their respective databases. For instance, a particular data item, such as a song, is associated with moods or feelings (grief, forgiveness, sympathy, love, sadness, happiness, etc.). The keywords are associated with particular songs by one of the e-card website operator(s), license holder of the data, and additional methods.

After entering the desired search criteria, the user commences the search by selecting the search button 370. The web browser 57 sends the search request to the server 65, which ensures that the search request is in the proper format, and forwards the request to the databases 70. The databases 70 receive the search request, and return the desired number of results back to the server 65, which ensures that the results are in the proper format, and forwards the data to the web browser 57.

The results of the search are displayed in the search results box 365. In some implementations, the search results box 365 includes a preview box 375. Upon selection of a particular result, the preview box 375 provides a preview to the user of the selected result. For instance, if an e-card template with an attached song is selected, the preview box 375 displays the selected e-card template in e-card viewer 380, plays the attached song or a portion thereof in media player 385, and displays the associated lyrics in script/lyrics viewer 390. The preview box 375 provides a preview of the material selected, and if a particular item (e.g., lyrics) are not associated with the selected result, that item is not depicted by the preview box 375. In some implementations, an area within the preview box 375 displays information or advertisements related to the item being previewed. In some implementations, the information or advertisements include links to external websites and/or internal web pages for the artists, charities, or organizations related to the item being previewed.

In some implementations, a user is directed to the e-card website webpage 350 (or the equivalent within an e-card application, e.g., being executed on a mobile device such as an iPhone™ or Android™ phone) from another application or website to initiate an e-card or media search. For instance, an additional “e-card” link may be included within the user's media player application. Upon the user selecting the e-card link, the webpage 350 is launched (either in a web browser or within a specific e-card generating application), and the media file that was currently highlighted or playing is used as the search criteria entered in to the webpage 350. In some implementations, an application being executed on a mobile device 1) receives audio input via a microphone, 2) uses the audio input to access a database and determine the most closely related media file, 3) then sends the media file information (e.g., title, artist, etc.) to the webpage 350, which returns the search results based on the information provided. A current mobile phone application embodying the first two steps (receiving audio and determining associated media information) is Shazam™.

Returning to FIG. 7, the calendar view mode section 245 works in combination with the calendar 240 to display information related to e-cards and media associated with particular days. In some implementations, the default view of the calendar 240 is of the current month with the most popular events displayed. The default calendar 240 is generated by the calendar generating module 105. The user can browse through the calendar by using the calendar 240 buttons: day/week/month view button 400, current button 405, previous time period button 410, and next time period button 415. The calendar 240 will display one day in day view, one week in week view, and one month in month view, which are selected using the radio buttons of the day/week/month view button 400. The user can move to the previous or next time period (time period being defined by the day/week/month view button 400), using the previous time period button 410 and next time period button 415, respectively. Additionally, the user can select a view type (song, event, artist, combo, or charities) and specify display criteria (e.g., most popular, least popular, random, and recommended for user) using the calendar view mode section 245. In some constructions, the calendar view mode 245 includes additional options, such as various music genres or movie genres that, when selected, update the calendar 240 to depict events, songs, e-cards, etc. that are related to the selected genre during the date range shown.

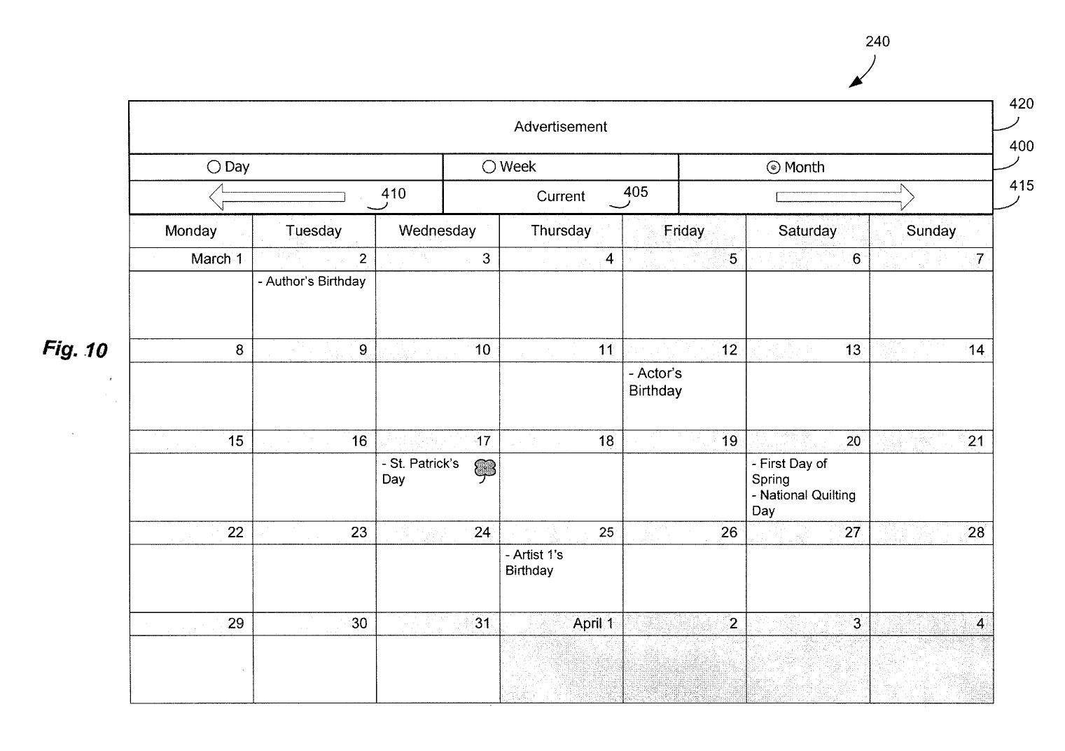

An example default calendar 240 is shown in FIG. 10. The most popular events of March (which is assumed to be the current month) are displayed. Multiple approaches are available to determine the “most popular” events. For instance, the most popular events may be statically set by the website operator. Alternatively, the most popular events may be those events for which the most e-cards are sent. In other instance, the most popular events may be those that generate the most viewing traffic (e.g., those calendar events that are selected the most by users, regardless of whether an e-card is later sent). The most popular events in March as shown in FIG. 10 include Author's birthday, St. Patrick's Day, the first day of spring, national quilting day, Actor's birthday, and Artist 1's birthday. If song view was selected from calendar view mode section 245, the calendar 240 would be updated to depict the most popular songs associated with events in the month of March. If combo view was selected, the most popular songs, events, artists, and charities associated with March would be displayed. In some implementations, the number of total items listed in the calendar 240 may be limited by the user or by a predetermined number.

In some implementations, selecting one of the events in the calendar 240 (e.g., actor's birthday) will link the user to a specific page related to the event, artist, or media listed. In some implementations, upon selection of an event of the calendar, one or more e-card templates or media related to the selected event are displayed to the user. For instance, an actor can upload to the server 65 a video birthday message and/or a specific e-card template to be associated with the actor's birthday. Such specialized media is identified as such (e.g., tagged or labeled) in the database such that the media is discoverable via a search query for the type of specialized media (e.g., video birthday messages). In some implementations, the calendar 240 includes an advertisement 420. The advertisement may be associated with a particular song, artist, event, charity, or other item.

The calendar 240 is generated by the calendar generating module 105. In some implementations, when the webpage module 100 is first generating the homepage 228, the calendar generating module 105 uses default calendar information including current month (e.g., March), month view, event view, and most popular. After the homepage 228 is generated and displayed in the web browser 57, including the generated default calendar 240, the user may adjust the calendar information. Upon adjustment of the calendar information (e.g., by selecting the “song view” in calendar view mode section 245), the calendar generating module 105 generates new calendar data for the calendar 240 displayed in the homepage 228.

After receiving calendar information (either default or user specified), the calendar generating module 105 accesses the databases 70 to retrieve the data for the calendar 240. For instance, the date, month, or week specified for the calendar 240 as well as the “most popular” selection is sent to the events database 140, assuming event view is selected in the calendar view mode section 245. The events database 140 then returns the most popular events for the time period specified. This returned data is then organized as calendar data and sent to the web browser 57 for display as the calendar 240. The requests sent from the calendar generating module 105 to the databases 70 are determined by the calendar information data supplied either as default calendar information or as specified by the user via the homepage 228.

In some implementations, the calendar 240 also displays thumbnails or symbols next to items listed therein. For instance, a thumbnail image of a four leaf clover is illustrated next to the St. Patrick's Day event on March 17. In some implementations, in addition or in place of the thumbnail images, a letter or symbol is associated with events using the same naming convention as used in the listing section 250. For example, the item listed in calendar 240 may be associated with a “C” if the item associated with a charity, an “F” if the item is associated with free e-cards or media, an “S” if the item is associated with a song, and a “V” if the item is associated with a video.

In some implementations, the calendar 240 is customized to a particular user based on user information from the user information database 137. For instance, once a user is logged in, the user account events database 137b is queried to ensure some or all of the events entered by the user that occur in the time period of the calendar 240 are displayed therein. For instance, if Al Smith is viewing the calendar 240 for March and selects “events view,” the calendar 240 displays that his mother's birthday is on March 17^{th} (see the user account events database 137b). In some implementations, St. Patrick's Day is also displayed on March 17^{th} in the calendar 240 for Al Smith. Moreover, Al Smith is associated with “environmental” events as shown in the user account preferences database 137c. Therefore, the first day of spring will be displayed on March 20^{th} of the calendar 240, whereas the national day of quilting may be left out of the calendar 240 because Al Smith does not have any preferences tied to that event.

The e-card generating module 110 generates previews for display in webpages 290, 310, and 350, and generates the e-cards for providing to the recipient computer 90 and/or physical card construction location 95. The e-card generating module 110 receives the components to build an e-card based on user selections via the e-card website as described above, for instance, with respect to FIGS. 7 and 8a-8c. A portion of the data received includes an e-card template from the e-card database 125. The template specifies, for instance, the number of sides of the e-card (e.g., front only; front and back only; front, inside left, inside right, and back; etc.), the size of the e-card, whether media is to be attached and, if so, the type of media that is to be attached, and the layout of the e-card (including the location of graphics, a media player, lyrics, scripts, or quotes, and text other on the e-card). The additional data items associated with the e-card template, e.g., media, graphics, text, are sent from the databases 70 to the e-card generating module 110, either by a specific request from the e-card generating module 110 or automatically by the databases 70 upon selection of a template. The e-card generating module 110 also receives recipient information and user specified details, such as text, colors, media, and/or e-card template-overriding information, sent from the user computer 55.

In some implementations, the e-card generating module 110 sends media or text data to the third party server 85 for generation of an image used in the e-card. For instance, in some implementations, the third party server 85 includes a collage generating module 453 that generates a collage image based on images or text received. Thereafter, the collage image is sent to the e-card generating module 110 for use in an e-card. The term “collage” is used in a broad sense to mean a visual combination of a portion or all of the text and/or images received by the collage generating module 453. An exemplary collage generating website includes the website operating under the name Wordle™.

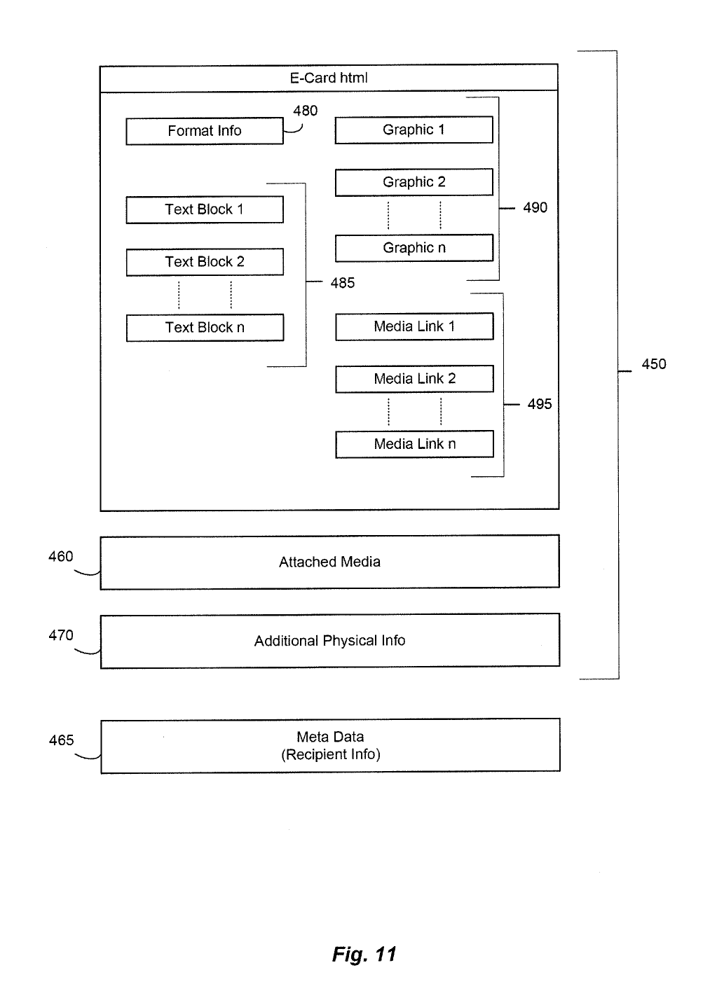

After receiving the information to generate the e-card or a preview thereof, the e-card generating module 110 assembles the e-card or preview. An exemplary e-card assembly 450 is depicted in FIG. 11. The e-card assembly 450 includes two parts: an e-card 455 and attached media 460, and the e-card assembly is associated with meta data 465. The e-card assembly 450 and meta data 465 are sent to a delivery module 467 within the e-card generating module 110. The delivery module 467 sends the e-card 455 and attached media 460 according to the specifics of the meta data 465. The meta data 465 includes, for instance, a list of one or more recipients and their respective one or more email addresses.

If the e-card assembly 450 is to be sent to the physical card construction location 95, the meta data includes an email address for the physical card construction location 95 and the e-card assembly 450 also includes a physical card information attachment 470. The physical card information attachment 470 lists, for instance, the recipient physical address information, shipping method selection (e.g., overnight or three-day), media format selection (e.g., compact disc or solid-state, portable memory device), and paper type.

In some implementations, the delivery module 467 does not send the e-card 455 and attached media 460 until receiving a payment confirmation from the payment module 120 that either the e-card 455 has been paid for by the user or that the e-card 455 is free.

In some implementations, the e-card 455 is encoded using HyperText Markup Language (“html”). Such an e-card 455 includes, for instance, information depicted in FIG. 11 encoded in html. The information in FIG. 11 that is encoded in html includes format information 480, text blocks (1-n) 485, graphics (1-n) 490, and media links 495 that link the html to the attached media 460. A html-reading device, such as a web-browser, is operable to receive the e-card assembly 450 and interpret the html code. Based on the interpretation, the html-reading device is further operable to display the e-card 455 including text and graphics, and play or display the attached media 460. The attached media includes a media item such as an e-book, video, song, or graphic, for example, from the media database 135.

The contents of the e-card 455 may be displayed as a single page or a pane within the page may include controls to “flip” through a multi-sided card (e.g., the card depicted in FIG. 12). For instance, the e-card 455 may be displayed using controls similar to the arrows of calendar 240 to cycle through the various sides of the e-card 455.

Upon receipt of the e-card assembly 450, a recipient 90 views the e-card 455 and perceives the media playing via an e-card reader 500 (e.g., a web browser, specific email application, or other html interpreting device) and a display 505, as shown in FIG. 1. The recipient is also able to save the attached media as a separate file in a local memory 510 of the recipient's receiving device, e.g., a hard drive of the recipient's computer. Thereafter, the attached media 460 is operable to be played by the recipient's preferred media player 515 without a connection to the Internet 60, since the media file is stored on a local memory device. Such media players 515 include iTunes™, Windows Media Player™, and Microsoft Reader™.

In some constructions, the recipient 90 receives an e-card assembly 450 on a mobile computing device, such as an iPhone™, Android™ phone, other mobile phone, iPad™, iTouch™, laptop, netbooks, tablets, etc. In some embodiments, an e-card is sent as a text message (e.g., a multimedia message (“MMS”) with any associated media being attached thereto.

In some constructions, attached media 460 that includes licensed media is delivered to the recipient with embedded digital rights management (“DRM”). The DRM prohibits or increases the difficulty in copying the licensed material without permission from the licensor. For instance, the DRM may limit the ability to play the media to media players registered to the recipient. Other DRM methods that limit the ability to copy licensed media or forward licensed media to non-recipients for their use are contemplated by embodiments of the invention.

FIG. 12 illustrates a multi-sided greeting card 550 constructed by physical card construction location 95. The greeting card 550 includes a front portion 555, back portion 560, left-inside portion 565 and right-inside portion 570. The left-inside portion 565 includes a compact disc (“CD”) holder 575 and CD 580, which includes media selected by the user. An e-card from which greeting card 550 is based would be illustrated similarly in a web-browser, with the exception of the left-inside portion 565 would not include the compact disc holder 575 or compact disc 580. In some constructions, a DVD, Blu-ray™, HD-DVD, or other disc storing digital data is used in place of the CD to store the e-card and/or media 460 for playback by the recipient. In other constructions, a universal serial bus (“USB”) flashdrive is used in place of the CD and the compact disc holder 575 is replaced with a securing portion more closely shaped to the flash drive.

The guest pages database 75 is a database for storing webpages for artists, organizations, charities, e-card designers, users, and other individuals associated with the e-card website. A guest, such as a musician, is associated with a webpage that is navigated to via the e-card website. For instance, selection of the browse guest pages option within the selection section 235 of the homepage 228 enables a user to browse the guest pages. The guest pages are organized and inter-linked akin to a social networking website.

Each guest page includes profile information, such as name, type (artist, charity, user, etc.), origination date (e.g., birth date of artist or founding date of a group), a list of likes and dislikes of the individual or group, links to other guest pages, and other information. In some implementations, the data for each guest page is stored in one or more databases similar to those of databases 70. For instance, each guest is associated with a guest account general information database, guest account events database, and guest account preferences database similar to the databases 137a-d making up user information database 137. Thus, a guest is able to store particular events, charities, and categories in which the guest is interested in promoting. In turn, the guest is able to promote particular e-cards, media, events, etc. to a user that visits the guest page. In some implementations, a user is able to suggest e-cards, media, events, etc. to the guest via the guest page.

In some implementations, the guest page includes the calendar 240 customized for the guest. For instance, if the guest is associated with environmental causes (e.g., via a guest account preferences database), the calendar 240 of the particular guest page visited by a user is displayed with those events, e-card templates, media, and/or charities for the time period of the calendar 240.

In some instances, the guest page is used for fundraising whereby the guest or other individuals are webcast live or pre-recorded videos are displayed. In live webcast scenarios, users may interact via the guest page via a chat window or other communication method. Alternatively, a charity may post exclusively recorded media on a charity guest page for purchase and/or inclusion in an e-card. The proceeds of a purchase may be split between the artist and charity, and the media may be offered for a limited time. The guest may also post media not particularly recorded for a charity and offer to donate a portion of the proceeds to a charity for limited time. Thus, in some instances, the guest may have a daily or weekly song to benefit a charity posted on a guest page.

Thus, even if a particular guest is not providing donations to a particular cause on a particular event, that guest is able to route users to another guest page, event, e-card template, and/or media that is providing donations. In some implementations, the guest page also includes counters that display the total number of related e-cards sent, media purchased, and/or donations made.

As noted above, some guest pages may be user-created (herein a “user page”), in contrast to charity- or artist-created. A user page similarly includes profile information, such as a username, age, address, marital/dating status, a profile image, user likes and dislikes, links to other guest pages, and other information. The user pages, together with the guest pages, collectively form “member pages” that function as a social network linked together by requesting and accepting offers to be linked. For instance, a first user sends a request to a second user asking for the second user to approve of being associated with the first user. The second user may accept or decline the request. If the second user accepts the request, the first user and the second user are now associated. Accordingly, a link may be provided on the first user's webpage that links to the second user's webpage, and vice versa. Additionally, in some instances, one or more user-specific events of the second user may be added to the first user's calendar either automatically after accepting the association or manually based on input from the first user. If the second user declines the request, the first user and the second user remain not associated.

The user pages may be associated with a user's email account from an email provider (e.g., Gmail™, Hotmail™, MobileMe™, Yahoo™, AOL™, etc.) to link the user to other user pages that the user already knows. The user page may include the listing mode 250, calendar view mode 245, or other components of the homepage 228. The user page may also include advertisements customized to preferences and/or characteristics of the user or the user's past activity on the e-card website. For instance, if the user specifies that he or she likes country music and has purchased country music-themed e-cards, an advertisement for a new country music album may be displayed on his or her user page. Various privacy settings may be specified by users to restrict access to the user page by other users, the public, etc.

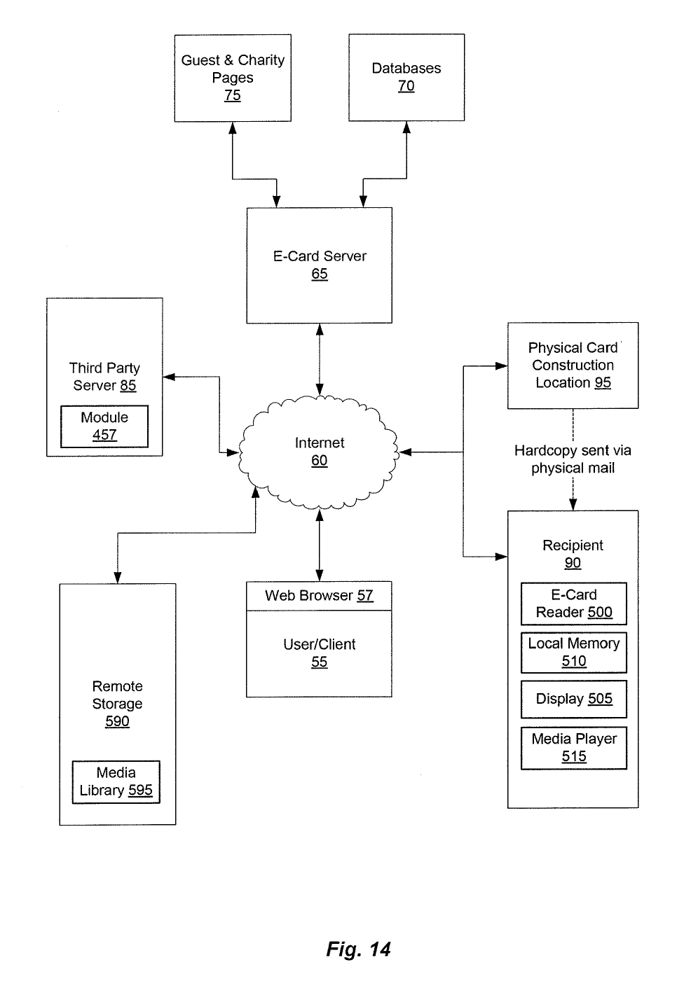

Users may use the media and e-card browsing functionality described above with respect to FIGS. 7-10 to post and send e-cards and media to other user pages. In some instances, the media and e-cards posted or sent remain remotely stored (from the recipient's perspective). For instance, the media or e-cards posted or sent may remain on one or more of the e-card server 65, databases 70, the third party server 85, and remote storage 590 (see, e.g., FIG. 14). In some instances, the user may create a media journal on the user page. The media journal is an electronic journal to which the user posts comments, photos, music, and/or videos. For instance, the user may post a song that the user is currently listening to and add a comment about the song. To post a song or video, particularly if it is a licensed song, the user may be required to pay a fee via the payment module 120. Alternatively, the user may have a subscription that allows posting or viewing of a certain amount or unlimited amount of media per month, year, etc.

Once posted, other users with the appropriate access rights to view the user page may listen to or view the posted media. In some instances, the amount of viewing by other users is limited, for example, to comply with licensing agreements. For instance, users may be allowed to listen to a song only once or to listen to only a portion of the song posted on another user page. However, links may also be provided to enable the viewer to launch a purchase screen to buy the media for his or her user page or other use.

A user may also post user-created e-cards and media on the user page to enable other users to view and/or purchase the e-cards and media or to include the media in e-cards. In some instances, the user or a charity receives a portion of the proceeds of the purchase.

Users also receive alerts when information or other status changes occur on pages linked to the user. For instance, if a user is linked to a guest page of an artist, the user may be alerted when that artist posts a new song, video, or comment. Users may specify what types of update/status information they receive from other users and artists and when they receive it (instantly, hourly, daily, weekly, etc.). The alert may be in a form of a posting on the user page, a text message, email, or other form of communication.

As noted above, an invitation-style e-card with RSVP functionality may be provided in some embodiments of the invention. In addition, an invitation page, similar to a guest page, may be created that provides information for the event related to the invitation. The information may include, for instance, time, place, invitees, hosts, registry information (potentially with discounts or marketing for advertisers related to the e-card website), RSVP list, etc. Furthermore, the invitation page may include a copy of the invitation-style e-card and any attached media.

Although the invention is described for use with a user computer 55 with a web browser 57, in some constructions, a user interacts with the server 65 as described above using a mobile device, in-store kiosk, or other electronic device with either a web browser 57 or an e-card software application being executed thereon. For instance, in some constructions, a user navigates the e-card website using an iPhone™, iTouch™, iPad™, Android™ phone, tablet, or other mobile computing device using either a web browser or a specific e-card application that facilitates card selection and generation as described herein. In some instances, kiosks or other electronic devices display web pages customized for their location. For instance, a default view for a calender displayed on a kiosk positioned in a movie theatre displays events and media related to actors and movies, as opposed to sports, etc.

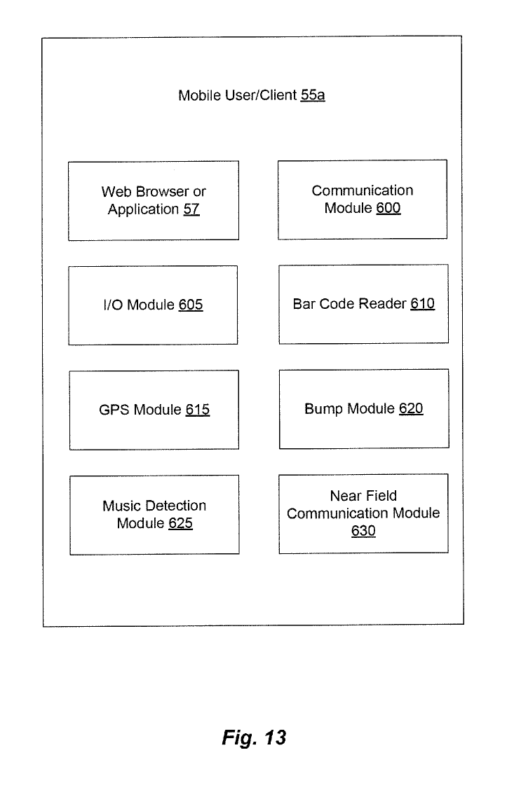

FIG. 13 illustrates a user computer 55 as a mobile device 55a, such as an iPhone™, iTouch™, iPad™, Android™ phone, tablet, or other mobile computing device, which includes the functionality of the user computer 55 as described above. The mobile device 55a may include additional functionality to take advantage of its portability. The mobile computing device 55a includes the web browser 57 (which may also be a particular e-card application or “app”), a communications module 600, an input/output (I/O) module 605, a bar code reader 610, a global positioning system (GPS) module 615, a bump module 620, a music detection module 625, and a near field communication module 630.

The communications module 600 enables the mobile device 55a and components thereof to communicate with the server 65 via the Internet 60 (e.g., over a cellular data connection, WiFi™ connection, Bluetooth™ connection, etc.). The I/O module 605 is operable to receive user input e.g., via a microphone, camera, keypad, touch screen, etc. The bar code reader 610 is operable to receive an image input from the I/O module 605 and to detect and decode a bar code or quick response (“QR”) code within the image. In some instances, the bar code reader 610 is a reader that detects and decodes a bar code or QR code with the use of a light source, a lens, and a light sensor that translates optical impulses into electrical impulses, rather than capturing a digital image and analyzing the image to detect and decode a bar code or QR code. For the remainder of the disclosure, a “bar code” should be interpreted to include a standard bar code, a QR code, or another encoded visual graphic, unless otherwise noted.

The GPS module 615 is operable to determine a global position of the mobile device 55a based on received GPS signals. The position may be displayed via a map module (not shown) that communicates with an output display of I/O module 605. Additionally, the global position information may be provided to the server 65 via the communications module 600. The music detection module is operable to analyze audio input via the I/O module 605 and determine whether the audio input matches a song in a song database. In some instances, the music detection module 625 forwards the audio input received to the third party server 85 via the communications module 600. The third party server then performs the analysis and returns a matching song's information to the music detection module 625. The music detection module 625 then displays the song information via a display of the I/O module 605.

The bump module 620 enables a user to transfer data to another nearby mobile device wirelessly. For instance, the bump module 620 wirelessly communicates with another bump module of the nearby mobile device via the communications module 600. The bump module 620 then detects when the two mobile devices are gently bumped together and, in response, performs a data transfer between the two mobile devices. In some instances, each mobile device includes acceleration sensors or other sensors to detect when the two devices bump together. The bump module 620 may be used to transfer media and/or e-cards from one user to another user.

The near field communication (NFC) module 630 enables short-range wireless communication between the mobile device 55a and another NFC circuit. Generally, the NFC module 630 is an active initiator, while the other NFC circuit is a passive or active target, although the NFC module 630 may be an active target in some instances. A passive NFC target is powered by a radio frequency (RF) field generated by the NFC module 630, while an active NFC target has its own power source. Generally, a set of instructions are executed by the NFC target once powered by and/or in range of the NFC module 630. The instructions enable the transmission of data between the NFC module 630 and the NFC target.

The server 65 may receive GPS data from the GPS module 615 when a user logs in to the e-card website to reach his or her user page. Logging in is an example of the GPS module 615 “checking in” to the server 65 to transfer GPS data. A separate action, such as selecting a graphic “check in” button displayed on the e-card website displayed on the mobile user/client 55a may also be used. The server 65 is operable to send location-specific communications to the user via postings on the user page, email, text message, etc., based on the user's location as provided by the sent GPS data. For example, exclusive events may be organized on short notice by a host or artist associated with the server 65. To inform users of the event, the server 65 sends a message to all users who have recently logged in to the server 65 and provided GPS data that indicates the user is within a particular geographic range (e.g., 5 miles or 10 miles) of the planned event. Such events can include concerts, book readings, book signings, movie screenings, music-video screenings, celebrity appearances, etc. In some instances, only certain members of the social network of the server 65 (“privileged members”) are permitted to send such location-specific invitations. For instance, the server 65 may only permit those that pay a certain amount (e.g., via the payment module 120) or that are pre-approved by an operator of the server 65.

In some instances, a unique bar code (also referred to as a member-specific admittance code) is provided to the user via the electronic communication to allow entrance to the event. The bar code may be metered to admit no more than a predetermined amount of persons into the event (e.g., one, two, five, etc.), allowing the user to forward the message to a certain number of friends or other users to enable their entrance as well. After or during the event, the server 65 may allow special postings by the user of the event. For example, the user may be provided a license to post recorded audio or video from the event. In some instances, the user pays a fee via the payment module 120 for the license to post audio and/or video of the event and other users that wish to view, or use in an e-card, the licensed postings must also pay a fee via the payment module 120. In some instances, a party associated with the server 65 records audio and/or video of the event and adds it to the media database 135. Those users that attended the event, which is determined by GPS data or bar code tracking, may receive a discounted price for viewing the media, downloading the media, re-posting the media, or including the media in an e-card.

In some instances, the user scans a bar code in a print, digital, or otherwise visual advertising medium using the I/O module 605 and decodes the bar code with bar code reader 610. The bar code is associated with the e-card website or with a particular media item, and, once decoded, is communicated to the server 65 via the communication module 600. The server 65, in turn, responds with options data for display via the I/O module 605. For instance, the user may be presented with options to buy a song, music video, movie, e-card, or other media associated with the bar code of the advertisement (e.g., an advertisement for an artist's new album). The user may purchase the media or e-card for himself or herself, post it on his or her user page, post it to another user page, or send it as an attachment to an e-card to another user or individual. In some instances, a user scans a bar code that encodes a message identifier, which is decoded by the bar code reader 610 into a digital identifier (e.g., a string of bits/bytes). The bar code reader 610 then forms a request for generation of an electronic message including the digital identifier. The request is then sent to the server 65 via the I/O module 605, along with recipient information that identifies a recipient. The server 65, in response to the request, generates an electronic message based on the digital identifier. The electronic message is then sent to the recipient. In some instances, the electronic message is sent along with a media file or a link to a media file that was also identified by the digital identifier decoded from the bar code. Thus, by scanning a bar code and entering recipient information, an electronic message with a media file or link to a media file is sent to the recipient.

As with other media and e-cards, in some instances, one or more charities are associated and receive a portion of proceeds from sales related to the media or e-card. Thus, a charity organization may take out a print advertisement in a magazine to promote a new song or album for an artist, wherein the advertisement includes a bar code. If the user scans the bar code and buys the album, the charity organization will receive a portion of the proceeds.

In some embodiments, rather than scanning a bar code to identify a song or artist, a user uses the I/O module 605 to import audio and provide the audio to the music detection module 625. The music detection module 625 then determines the artist, song, and album, and provides similar options as described above with respect to the bar code scanner.

In some implementations, an e-card 455 includes items either in addition to or in place of the attached media 460. In one implementation, the additional item includes a gift card. For instance, the gift card may be a small plastic card including a magnetic strip storing gift card value and other information. In another implementation, the e-card includes embedded gift card data in, for instance, a bar code. In the bar code implementation, the e-card is printed (either by the recipient or the physical card construction location 95) and includes the bar code, which can be scanned by a merchant that accepts bar code gift cards. In other implementations, the e-card 455 includes a coupon or other item conferring a discount accepted by merchants. In still other implementations, the e-card 455 includes a paid advertisement randomly selected from a list of willing advertisers maintained by the website operator. In other implementations, the e-card 455 includes paid advertisements that are selected based on one or more of information about the user that caused the e-card 455 to be generated, information about the recipient of the e-card 455, or the content of the e-card 455 (e.g., the particular media 460 or e-card template selected). In some implementations, the merchant for which the gift card or discount is directed is the artist(s) associated with the media or the license holder of the media sent with the e-card 455.

In some implementations, the e-card 455 is not sent with attached media 460. Instead, the media links 495 provide links to media stored remotely from the recipient 90, for instance, on a server. To access the media, a media player or e-card reader of the recipient 90 uses the included media links 495 as an address to the remotely stored media. Additionally, in some embodiments, the media links 495 include an embedded identification of the recipient for authorization purposes. The media player or e-card reader of the recipient 90 streams the media for use in conjunction with viewing the e-card 455 and/or for uses independent of the e-card 455. In other words, the recipient 90 is operable to retain the media links 495 for later streaming of the media associated with the e-card 455. In some implementations, an e-card 455 is provided with media links 495 that link to both attached media 460 and remotely stored media.

In some implementations, the e-card 455 is sent by email to the recipient 90, but the e-card 455 is not sent with attached media 460. Instead, when the e-card 455 is sent to the recipient 90, the media associated with the e-card 455 is sent to a media library of the recipient 90 that is stored remotely on remote storage 590. See, e.g., FIG. 14, which includes the remote storage 590 in addition to the elements of FIG. 1. The remote storage 590 includes a remotely stored media library 595 accessible by the recipient 90 via one or more network connections, including the Internet 60. In conjunction with sending e-card 455, the e-card server 65 communicates with the remote storage 590 via the Internet 60 to provide the media associated with the e-card 455. The media associated with the e-card 455 is sent along with an identification of the intended recipient 90 or an identification of the remotely stored media library 595 of the recipient 90. The remote storage 590 stores the received media associated with the e-card 455 in the remotely stored media library 595. In some instances, the recipient 90 may be required to set permissions of the media library 595 to allow the e-card server 65 access. In some instances, the e-card server 65 itself contains the remote storage 590 and the recipient 90 registers with the e-card server 65 before direct sending of media to the media library 595 is permitted.

In some implementations, the e-card 455 includes a message indicating that the media associated with the e-card 455 has been remotely stored in the media library 595. In other instances, the e-card 455 includes a message asking whether the recipient 90 agrees to the new media associated with the e-card 455 being sent and stored in the media library 595. For instance, the e-card 455 may include a link to a website that includes an “accept” and a “decline” button, which results in the media being stored or not being stored in the media library 595, respectively. In other instances, the “accept” and “decline” buttons are embedded in the email. Upon selecting one of the embedded buttons, the recipient 90 is taken to the respective accept or decline webpage, which causes the e-card server 65 to be notified of the decision of the recipient 90. In some instances, the media library 595 tags or otherwise labels media received in conjunction with an e-card 455, such that the recipient 90 is able to quickly identify the media provided via e-cards. In some instances, the media sent in conjunction with an e-card 455 is stored in a particular subsection of the media library 595 to allow the recipient 90 to easily identify such media.

In some instances, the computer of the recipient 90 is operable to connect to the media library 595 to play the media upon the recipient 90 accessing the e-card 455 (e.g., via an email program). The recipient 90 is also able to access the media associated with the e-card 455 stored in the media library 595 using other software and hardware devices as would be used by the recipient 90 to access other remotely stored media (e.g., using a local media player). In some instances, the media library 595 limits access to a certain number of simultaneous remote users (e.g., one user, two users, etc.) and/or devices of the recipient 90 (e.g., one personal computer, one mobile phone, etc.). These limits prevent potential improper use of licensed media.

In some instances, the media associated with the e-card 455 is not physically sent and stored in the media library 595. Rather, the remote storage 590 already includes media owned by one or more parties (other than the recipient 90), and the recipient 90 is granted a license to access the media remotely (e.g., for streaming media on a local media player). The license may specify various limitations on accessing the music, such as: the term of the license (e.g., 30 days, 1 year, perpetual), number of devices that can access the media simultaneously or in total (e.g., one, two, no limit), the types of devices or software that can access the media (iPhone™ only, iTunes™ only, etc.), the number of different individuals or entities that can access the media, as well as other limitations. The particular license provided may be selected by the user when purchasing and customizing the e-card 455 as discussed above. In some instances, the recipient is already registered to access other licensed media stored on the remote storage 590, and the license accompanying the e-card 455 enables the recipient 90 to access media not previously available to the recipient 90.

This remote storing of information accessible by a recipient over one or more networks including the Internet is sometimes referred to as “cloud computing,” as resources (e.g., memory) located remotely are being shared by multiple users. Although the remote storage 590 is being shared, portions of the remote storage 590 may be particularly reserved for individual users, for example, using passwords, encryption, and other security measures. Thus, users are able to safely and securely store personal data and media remotely for access from a variety of locations. Additionally, in some implementations, the e-card 455 is sent with the attached media 460 to the recipient 90 and, in addition, either the media is sent to the media library 595 of the recipient 90 or a license is granted allowing the recipient to remotely access the media.

In some implementations, after causing an e-card that includes media (e.g., media 460) to be generated and sent, the user is presented with the option to purchase (and download) the same media. In some implementations, the media is offered at a discount to the user based on their purchase of the e-card and media for the recipient 90. In some implementations, the discount is increased based on the number of recipients of the generated e-card 455 and media 460. For instance, the media may be half-price if the user purchases five e-cards (or lists five recipients for a single e-card) and free if the user purchases ten e-cards (or lists ten recipients for a single e-card).

In some implementations, after causing an e-card that includes media (e.g., media 460) to be generated and sent, the user is presented with the option to purchase related clothing, bags, posters, etc. with graphics, lyrics, and/or the e-card itself printed or otherwise included thereon. Additionally, an embedded chip that plays media (e.g., audio) via a miniature speaker may also be secured to the clothing for playing the media associated with the generated e-card. The e-card website may offer discounts based on the purchase of the related clothing, similar to the discounts offers described above. In some implementations, such clothing, bags, and posters with lyrics, graphics, an e-card, and associated with media are sent to the recipient 90 in addition to or in place of an e-card. In some implementations, generation of clothing and other merchandise including media is an independent process from e-card selection generation or occurs in parallel with e-card selection and generation. For instance, the media databases are searchable for media that can be included on available merchandise.

In some implementations, after causing an e-card to be generated and sent, the user is presented with links to external websites, internal web pages, and/or products related to one or more charities, organizations, artists, and/or media related to the e-card generated. Thus, after the e-card is generated, the website provides an opportunity to display advertisements, information, or products that may be desired by the user, based on their recent e-card generation.

In some implementations, after causing an e-card to be generated and sent, the user is presented with a confirmation page, which displays information related to the e-card transaction, such as purchase price, expected delivery date, and tracking information. In some implementations, the confirmation page also includes tax information related to a charitable donation made based on the purchase of the e-card. In other implementations, the server 65 tracks financial information for users, organizations, and charities, based on e-card transactions over time and, at appropriate time (such as the end of a fiscal or tax year), the server 65 provides the financial information to the respective user, organization, or charity. For instance, the financial information may include monies earned via the e-card website, charitable donations made or received via the e-card website, etc.

Although the databases within databases 70 are depicted as storing data in a table format with particular rows and columns, the databases may store information in a variety of ways. In some constructions, some or all of the databases 70 are integrated with the server 65. In other constructions, some or all of the databases 70 are coupled to the server 65 using one or more networks such as a local area network, a wide area network, a cellular network, the Internet 60, and other networks. Furthermore, in some constructions, individual databases within databases 70 are separated into multiple databases that may be located in different locations and coupled together or to the server 65 using various networks and devices. In some implementations, the server 65 is one or more of an Xserve server offered by Apple, a PowerEdge server offered by Dell, a System x or BladeCenter server offered by IBM, Blade server offered by Oracle, or the like. In some implementations, the databases 70 are maintained by database software such as Microsoft SQL Server, Oracle Database, IBM DB2, or the like.

Thus, the invention provides, among other things, systems and methods of generating e-cards including licensed media. In some embodiments, the e-card is sent as an email with licensed media attached. The licensed media is played upon receipt and viewing of the e-card on an html-reading application (e.g., a web browser or email application). Additionally, the licensed media is downloadable to a local memory for subsequent playing without an Internet connection. Purchase of an e-card including licensed media, in some instances, results in proceeds being directed to multiple entities. For instance, the proceeds may be directed to both the license holder and a charitable organization. Embodiments of the invention also provide a user the ability to browse and search e-cards, events, and media and to receive an indication during browsing and view search results of whether such e-cards, events, and media are associated with a charitable organization.

1. A method for generating an electronic greeting card comprising:
receiving, by a server, user information indicating preferences of a user;
generating, by the server, a web page for the user, wherein the web page includes an event calendar;
associating a holiday with the user based on the user information;
populating the event calendar with user-specific events, including the holiday;
sending the web page to a remote user device;
receiving an event selection from the user, wherein the event selection includes the user selecting an event of the user-specific events of the event calendar;
sending, by the server, an electronic greeting card template based on the event selection to the user;
receiving recipient information identifying a recipient for the electronic greeting card template;
generating an electronic greeting card based on the electronic greeting card template and with at least one of a media file and a link to the media file; and
sending the electronic greeting card to the recipient.

2. The method of claim 1, wherein the web page is part of a social networking website that selectively associates members, including the user, with each other based on an association request and confirmation process, and includes links to pages of associated members.

3. The method of claim 2, wherein populating the event calendar with user-specific events further includes populating the event calendar with an event related to a first member associated with the user.

4. The method of claim 1, further comprising:
storing, in an events database, a plurality of holidays, wherein the plurality of holidays each have respective characteristics associated therewith; and
storing the user information in a user information database,
wherein associating the holiday with the user based on the user information includes identifying a relationship between a characteristic of the holiday and a preference indicated by the user information.

5. The method of claim 1, further comprising receiving a media file selection that identifies the media file for the electronic greeting card.

6. The method of claim 1, further comprising, in response to the event selection, sending to the user a list of media files including the media file, wherein the list of media files includes at least one of licensed music files and licensed video files.

7. An electronic greeting card server comprising:
a website module that generates a web page for a user, wherein the web page includes an event calendar;
a user information module that receives user information indicating preferences of a user;
a calendar generating module that
associates a holiday with the user based on the user information, and
populates the event calendar with user-specific events, including the holiday; and
an e-card generating module that
receives an event selection from the user, wherein the event selection identifies an event of the user-specific events,
sends, to the user, an electronic greeting card template based on the event selection,
receives recipient information identifying a recipient for the electronic greeting card template,
generates an electronic greeting card based on the electronic greeting card template and with at least one of a media file and a link to the media file, and
sends the electronic greeting card to the recipient.

8. The electronic greeting card server of claim 7, wherein the web page is part of a social networking website that selectively associates members, including the user, with each other based on an association request and confirmation process, and includes links to pages of associated members.

9. The electronic greeting card server of claim 8, wherein populating the event calendar with user-specific events further includes populating the event calendar with an event related to a first member associated with the user.

10. The electronic greeting card server of claim 7, further comprising:
an events database storing a plurality of holidays and respective characteristics associated with each of the plurality of holidays; and
a user information database storing the user information,
wherein associating the holiday with the user based on the user information includes the calendar generating module identifying a relationship between a characteristic of the holiday and a preference indicated by the user information.

11. The electronic greeting card server of claim 7, wherein the e-card generating module further receives a media file selection that selects the media file for the electronic greeting card.

12. The electronic greeting card server of claim 7, wherein, in response to the event selection, the e-card generating module further sends to the user a list of media files including the media file, wherein the list of media files includes at least one of licensed music files and licensed video files.

13.-22. (canceled)

23. The method of claim 1, further comprising:
causing display of a list of related items to the user, the related items including at least one of a clothing item, a bag, and a poster associated with the media file;
receiving a selection of at least one of the related items; and
sending the selected at least one of the related items to the recipient.

24. A method for generating an electronic greeting card comprising:
sending, by a client device, user information indicating preferences of a user;
receiving, by the client device, a web page including an event calendar;
displaying, on the client device, the event calendar populated with user-specific events, including a holiday associated with the user based on the user information;
selecting an event of the user-specific events of the event calendar;
receiving, by the client device, an electronic greeting card template based on the event selection;
providing recipient information identifying a recipient for the electronic greeting card template; and
requesting
generation of an electronic greeting card based on the electronic greeting card template and with at least one of a media file and a link to the media file, and
sending the electronic greeting card to the recipient.

25. The method of claim 13, wherein the web page is part of a social networking website that selectively associates members, including the user, with each other based on an association request and confirmation process, and includes links to pages of associated members.

26. The method of claim 14, wherein the event calendar is populated with an event related to a one of the associated members of the user.

27. The method of claim 13, wherein the holiday of the event calendar is associated with characteristics, and wherein the event calendar is populated with the holiday based on an identified relationship between at least one of the characteristics of the holiday and a preference indicated by the user information.

28. The method of claim 13, further comprising selecting a media file for the electronic greeting card.

29. The method of claim 13, further comprising, in response to the event selection, receiving a list of media files including the media file, wherein the list of media files includes at least one of licensed music files and licensed video files.

30. The method of claim 13, further comprising:
displaying a list of related items to the user, the related items including at least one of a clothing item, a bag, and a poster associated with the media file; and
selecting at least one of the related items to be sent to the recipient.
